(19) United States
(12) Patent Application Publication
(10) Pub. No.: US 2006/0007835 A1
(43) Pub. Date: Jan. 12, 2006

(54) Optical head device, method of manufacturing the same, and optical information recording and/or playback apparatus

(76) Inventor: Ryuichi Katayama, Tokyo (JP)

Correspondence Address: OSTROLENK FABER GERB & SOFFEN, 1180 AVENUE OF THE AMERICAS, NEW YORK, NY, 100368403, US

(21) Appl. No.: 10/527,128

(22) PCT Filed: Apr. 30, 2004
(86) PCT No.: PCT/JP04/06333

§ 371 Date: Mar. 8, 2005

(30) Foreign Application Priority Data
May 8, 2003 (JP) 2003-130814

(51) Int. Cl. G11B 7/00

(52) U.S. Cl. 369/112.01; 369/44.11

(57) ABSTRACT

In order to correct specific aberration that occurs within an optical system, a plurality of aberration correction optical elements (4) with differing amounts and/or signs of aberration correction are prepared. The amount and sign of the aberration that is generated within the optical system, except the aberration correction optical elements (4), between a semiconductor laser (1) and an objective lens 6, is then measured using an interferometer or the like. Based on the measured amount and sign of the aberration, where necessary, the aberration correction optical element (4) which, following correction, is most capable of minimizing the residual RMS wave-front aberration is selected from amongst the plurality of different aberration correction optical elements (4), and is then inserted into the optical system between the semiconductor laser (1) and the objective lens (6).

### TECHNICAL FIELD

The present invention relates to an optical head device for recording to, and/or conducting playback from, an optical recording medium, as well as a method of manufacturing such an optical head device and an optical information recording and/or playback apparatus, and relates more particularly to an optical head device in which the various types of aberration that develop within the optical system of the optical head device can be easily corrected, as well as a method of manufacturing such an optical head device and an optical information recording and/or playback apparatus that incorporates such an optical head device.

### BACKGROUND ART

The recording density in an optical information recording and playback apparatus is inversely proportional to the square of the diameter of the focused light spot that the optical head device forms on the surface of the optical recording medium. In other words, the recording density increases as the diameter of the focused light spot decreases. The diameter of the focused light spot is proportional to the wavelength of the light source within the optical head device, and inversely proportional to the numerical aperture of the objective lens. In other words, the diameter of the focused light spot decreases as the wavelength of the light source is shortened, and as the numerical aperture of the objective lens is increased.

By the way, in the optical system of the optical head device, factors such as manufacturing error and adjustment error of the optical components cause a variety of aberrations to develop, including coma, spherical aberration, astigmatism, and arrow aberration. For example, coma and astigmatism develop when the center of the plane of incidence and the center of the exit plane for the objective lens are not aligned, and spherical aberration arises when the distance between the plane of incidence and the exit plane for the objective lens is different from the design value. When any of these various aberrations develop within the optical system of the optical head device, the shape of the focused spot is disturbed, causing a deterioration in the recording and playback characteristics. The respective magnitudes of the coma, spherical aberration, and astigmatism are inversely proportional to the wavelength of the light source, and are proportional to the cube, the biquadratic, and the square of the numerical aperture of the objective lens, respectively. As a result, shorter wavelengths for the light source and larger numerical aperture values for the objective lens produce narrower aberration margins on the recording and playback characteristics. Accordingly, in optical head devices and optical information recording and playback apparatus in which the wavelength of the light source has been reduced and the numerical aperture of the objective lens has been increased in order to increase recording density, the various types of aberration that occur within the optical system of the optical head device must be corrected to ensure minimal deterioration of the recording and playback characteristics.

An example of a conventional optical head device that is capable of correcting the various types of aberration is an optical head device provided with a liquid crystal optical element within the optical system (for example, see “Optics Design,” vol. 21, pp. 50 to 55, and Japanese Patent Laid-Open Publication No. 2002-373441). FIG. 14 is a block diagram showing a conventional optical head device with a liquid crystal optical element provided within the optical system. As shown in FIG. 14, this conventional optical head device is provided with a semiconductor laser 1, and in the path of the laser beam emitted from this semiconductor laser 1 are provided a collimator lens 2 for collimating the laser beam from the semiconductor laser 1 and forming a parallel beam, a polarization beam splitter 3 which transmits P-polarized light and reflects S-polarized light in a predetermined direction, a liquid crystal optical element 18 for controlling the phase distribution of the incident beam and then transmitting the beam, a ¼ wavelength plate 5 which, when irradiated with linearly polarized light beams oscillating in perpendicular directions, applies a ¼ wavelength phase difference to the two beams, and an objective lens 6 for converging the parallel light beam, and a disc 7 that functions as the optical recording medium is positioned at the focus of this objective lens 6. Furthermore, in the path of the light beam reflected by the polarization beam splitter 3 are disposed a cylindrical lens 8, a lens 9, and a photodetector 10. The photodetector 10 is positioned at the midpoint of the two focal lines formed by the compound lens comprising the cylindrical lens 8 and the lens 9.

In the conventional optical head device shown in FIG. 14, the semiconductor laser 1 that functions as the light source emits a laser beam, and this laser beam is collimated and converted to a parallel beam by the collimator lens 2, is subsequently irradiated onto the polarization beam splitter 3 as P-polarized light and is substantially transmitted, passes through the liquid crystal optical element 18, passes through the ¼ wavelength plate 5 and undergoes conversion from linearly polarized light to circularly polarized light, and is then focused onto the surface of the disc 7 that represents the optical recording medium by the objective lens 6. The light beam is then reflected off the surface of the disc 7. The reflected light beam from the surface of the disc 7 passes through the objective lens 6 in the opposite direction, passes through the ¼ wavelength plate 5 and undergoes conversion from circularly polarized light to linearly polarized light in which the direction of polarization is perpendicular to that of the light beam within the onward optical path, passes through the liquid crystal optical element 18 in the opposite direction, is subsequently irradiated onto the polarization beam splitter 3 as S-polarized light and is substantially reflected, and then has an astigmatism applied by transmission through the cylindrical lens 8 and the lens 9, before being received at the photodetector 10.

FIG. 15(a) through FIG. 15(c ) are plan views showing liquid crystal optical elements, wherein (a) shows a liquid crystal optical element 18a for correcting coma, (b) shows a liquid crystal optical element 18b for correcting spherical aberration, and (c) shows a liquid crystal optical element 18c for correcting astigmatism. The construction of these liquid crystal optical elements 18a, 18b, and 18c is disclosed, for example, in the aforementioned reference document (“Optics Design,” vol. 21, pp. 50 to 55). The broken lines in the figures correspond with the effective area for the objective lens 6. The liquid crystal optical elements 18a to 18c control the refractive index within each region, thereby controlling the phase distribution of the incident light beam, by controlling the voltage applied within each of the regions.

As shown in FIG. 15(a), the liquid crystal optical element 18a is divided into 5 regions 19a to 19e. A first voltage V1 is applied to the regions 19b and 19e, a second voltage V2 is applied to the region 19a, and a third voltage V3 is applied to the regions 19c and 19d. If V1−V2=V2−V3=V, then varying the voltage V alters the coma of the transmitted light beam. By adjusting the voltage V, a coma aberration that cancels out the coma generated within the optical system can be generated by the liquid crystal optical element 18a, thus enabling correction of the coma.

Furthermore, as shown in FIG. 15(b), the liquid crystal optical element 18b is divided into 5 regions 19f to 19j. A first voltage V1 is applied to the region 19h, a second voltage V2 is applied to the regions 19g and 19i, and a third voltage V3 is applied to the regions 19f and 19j. If V1−V2=V2−V3=V, then varying the voltage V alters the spherical aberration of the transmitted light beam. By adjusting the voltage V, a spherical aberration that cancels out the spherical aberration generated within the optical system can be generated by the liquid crystal optical element 18b, thus enabling correction of the spherical aberration.

As shown in FIG. 15(c ), the liquid crystal optical element 18c is divided into 5 regions 19k to 19o. A first voltage V1 is applied to the regions 19l and 19m, a second voltage V2 is applied to the region 19k, and a third voltage V3 is applied to the regions 19n and 19o. If V1−V2=V2−V3=V, then varying the voltage V alters the astigmatism of the transmitted light beam. By adjusting the voltage V, an astigmatism that cancels out the astigmatism generated within the optical system can be generated by the liquid crystal optical element 18c, thus enabling correction of the astigmatism.

Head devices that incorporate an aberration correction device different from the liquid crystal optical elements described above are also being developed. For example, head devices incorporating an aberration correction device comprising a plurality of optical elements and movable means for controlling the relative positions of this plurality of optical elements have been disclosed (for example, see Japanese Patent Laid-Open Publication No. 2000-113494 and Japanese Patent Laid-Open Publication No. 2001-043549). In these types of head devices, by using the movable means to control the relative positional relationship between the plurality of optical elements in accordance with the aberration generated within the optical system of the head device, the aberration generated by the aberration correction device can be controlled so as to cancel out the aberration of the head device.

Furthermore, technology for incorporating, into a head device, an aberration correction element that has been preadjusted so as to cancel out the aberration of the head device optical system has also been disclosed (for example, see Japanese Patent Laid-Open Publication No. 2003-006909).

However, the conventional technologies described above suffer from the following types of problems. In a conventional optical head device shown in FIG. 14, in order to enable the various types of aberration generated within the optical system to be corrected by the liquid crystal optical element 18, drive circuits (not shown in the figure) are required for applying voltages to each of the different regions of the liquid crystal optical element 18. Furthermore, a control circuit (not shown in the figure) for controlling these drive circuits is also required. Accordingly, the structure of an optical information recording and playback apparatus that uses such an optical head device is extremely complex, resulting in increased costs and a larger apparatus.

Similarly, a head device that incorporates an aberration correction device comprising a plurality of optical elements and movable means also requires a circuit for operating the movable means, meaning the structure of the optical information recording and playback apparatus becomes more complex.

In addition, the technology wherein an aberration correction element that has been preadjusted so as to cancel out the aberration of the head device optical system is incorporated within the head device suffers from the following types of problems. Namely, there is an instrumental error component associated with the aberration within the head device optical system, meaning that even for a plurality of head devices manufactured using the same design, the aberration of the optical system still varies from device to device. As a result, even if the same aberration correction device is built into such a plurality of head devices, the aberration cannot necessarily be corrected accurately within all the devices. Furthermore, if an optimally adjusted aberration correction device is fabricated for each individual head device, then the manufacturing costs for the head device increase dramatically.

### DISCLOSURE OF THE INVENTION

An object of the present invention is to provide an optical head device which does not require a special drive circuit or control circuit, and which is able to simply and cheaply correct the various types of aberration generated within the optical system of the optical head device, as well as a method of manufacturing such an optical head device, and an optical information recording and/or playback apparatus, by solving the aforementioned problems associated with conventional optical head devices and optical information recording and/or playback apparatus.

An optical head device according to the present invention comprises a light source, an objective lens for focusing light emitted from this light source onto an optical recording medium, a photodetector for detecting light reflected off the optical recording medium, and one or more aberration correction optical elements, which are disposed within a path of the light between the light source and the objective lens, and correct aberration of the light generated within that path, wherein the one or more aberration correction optical elements are selected from amongst a plurality of different aberration correction optical elements, in accordance with the aberration.

In the present invention, the aberration correction optical elements provided within the light path enable correction of the various types of aberration that are generated within that light path. Moreover, because these aberration correction optical elements are selected in accordance with the aforementioned aberration, from amongst a plurality of different aberration correction optical elements that have been prepared in advance, the aberration can be corrected accurately, and drive circuits for driving the aberration correction optical elements are unnecessary. Furthermore, a control circuit for controlling such drive circuits is also unnecessary. In addition, an optimally adjusted aberration correction optical element need not be fabricated for each individual head device. As a result, the various types of aberration can be corrected simply, and at low cost, without requiring the use of a complex structure for the optical information recording and/or playback apparatus that incorporates the optical head device.

Furthermore, the above plurality of different aberration correction optical elements preferably provide correction for mutually different types, signs, and quantities of aberration. So doing enables aberration correction to be achieved in a large number of cases, regardless of the aberration that develops within the light path.

In addition, at least one of a light incident surface and a light exit surface of the above aberration correction optical element may be a stepped surface including at least 2 steps. This enables the aberration correction optical elements to be fabricated more easily.

Furthermore, at least one of a light incident surface and a light exit surface of the above aberration correction optical element may be formed as a curved surface. This enables aberration to be corrected with better accuracy.

A method of manufacturing an optical head device according to the present invention comprises the steps of assembling an optical system including a light source, an objective lens for focusing the light emitted from this light source onto an optical recording medium, and a photodetector for detecting light reflected off the optical recording medium, measuring the aberration generated in a light path within the optical system from the light source to the objective lens, and selecting, from amongst a plurality of different aberration correction optical elements, based on the results of the measured aberration, one or more aberration correction optical elements for correcting the aberration, and then installing the optical element or elements within the light path of the optical system.

An optical information recording and/or playback apparatus according to the present invention comprises the aforementioned optical head device, a first circuit for driving the light source, a second circuit for generating a playback signal and an error signal based on an output signal from the aforementioned photodetector, and a third circuit for controlling the position of the objective lens based on the error signal.

According to the present invention, by installing one or more aberration correction optical elements which have been selected from amongst a plurality of different aberration correction optical elements in accordance with the aberration, the various types of aberration that occur within the optical system of an optical head device can be correctly easily, without requiring a special drive circuit or control circuit. As a result, both the cost and the size of the optical information recording and/or playback apparatus can be reduced.

### BRIEF DESCRIPTION OF THE DRAWINGS

FIG. 1 is a block diagram showing an optical information recording and playback apparatus according to a first embodiment of the present invention;

FIG. 2(a) is a plan view showing an aberration correction optical element 4a for correcting coma in the present embodiment, and FIG. 2(b) through FIG. 2(e) are cross-sectional views shown along the line A-A′ in FIG. 2(a);

FIG. 3(a) is a plan view showing an aberration correction optical element 4b for correcting spherical aberration in the present embodiment, and FIG. 3(b) through FIG. 3(e) are cross-sectional views shown along the line B-B′ in FIG. 3(a);

FIG. 4(a) is a plan view showing an aberration correction optical element 4c for correcting astigmatism in the present embodiment, and FIG. 4(b) through FIG. 4(e) are cross-sectional views shown along the line C-C′ in FIG. 4(a);

FIG. 5(a) is a plan view showing an aberration correction optical element 4d for correcting arrow aberration in the present embodiment, and FIG. 5(b) through FIG. 5(e) are cross-sectional views shown along the line D-D′ in FIG. 5(a);

FIG. 6(a) through FIG. 6(h) are graphs showing the wave-front aberration for the optical system or the aberration correction optical element 4a, wherein the horizontal axis represents the position along the cross-section in the X direction that passes through the center of the aberration correction optical element 4a, and the vertical axis represents the amount of aberration;

FIG. 7(a) through FIG. 7(h) are graphs showing the wave-front aberration for the optical system or the aberration correction optical element 4b, wherein the horizontal axis represents the position along the cross-section in the X direction that passes through the center of the aberration correction optical element 4b, and the vertical axis represents the amount of aberration;

FIG. 8(a) through FIG. 8(h) are graphs showing the wave-front aberration for the optical system or the aberration correction optical element 4c, wherein the horizontal axis represents the position along the cross-section in the X direction that passes through the center of the aberration correction optical element 4c, and the vertical axis represents the amount of aberration;

FIG. 9(a) through FIG. 9(h) are graphs showing the wave-front aberration for the optical system or the aberration correction optical element 4d, wherein the horizontal axis represents the position along the cross-section in the X direction that passes through the center of the aberration correction optical element 4d, and the vertical axis represents the amount of aberration;

FIG. 10(a) is a plan view showing an aberration correction optical element 4e for correcting coma in a second embodiment of the present invention, and FIG. 10(b) through FIG. 10(e) are cross-sectional views shown along the line E-E′ in FIG. 10(a);

FIG. 11(a) is a plan view showing an aberration correction optical element 4f for correcting spherical aberration in the present embodiment, and FIG. 11(b) through FIG. 11(e) are cross-sectional views shown along the line F-F′ in FIG. 11(a);

FIG. 12(a) is a plan view showing an aberration correction optical element 4g for correcting astigmatism in the present embodiment, and FIG. 12(b) through FIG. 12(e) are cross-sectional views shown along the line G-G′ in FIG. 12(a);

FIG. 13(a) is a plan view showing an aberration correction optical element 4h for correcting arrow aberration in the present embodiment, and FIG. 13(b) through FIG. 13(e) are cross-sectional views shown along the line H-H′ in FIG. 13(a);

FIG. 14 is a block diagram showing a conventional optical head device with a liquid crystal optical element provided within the optical system; and

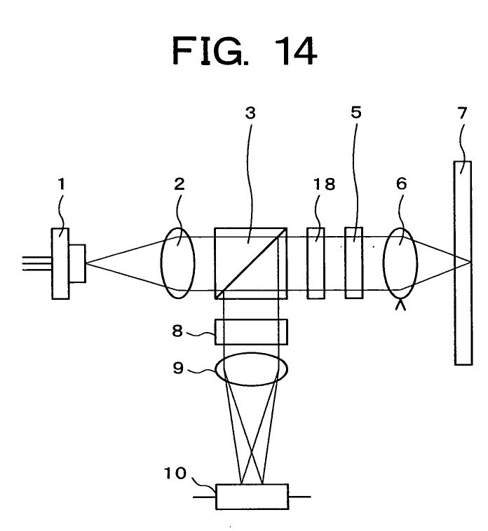

FIG. 15(a) through FIG. 15(c ) are plan views showing liquid crystal optical elements, wherein FIG. 15(a) shows a liquid crystal optical element 18a for correcting coma, FIG. 15(b) shows a liquid crystal optical element 18b for correcting spherical aberration, and FIG. 15(c ) is a liquid crystal optical element 18c for correcting astigmatism.

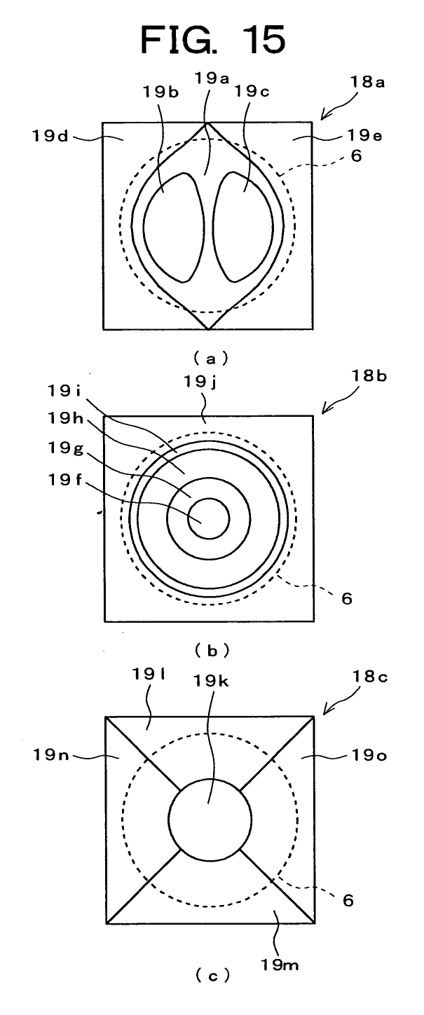

### BEST MODE FOR CARRYING OUT THE INVENTION

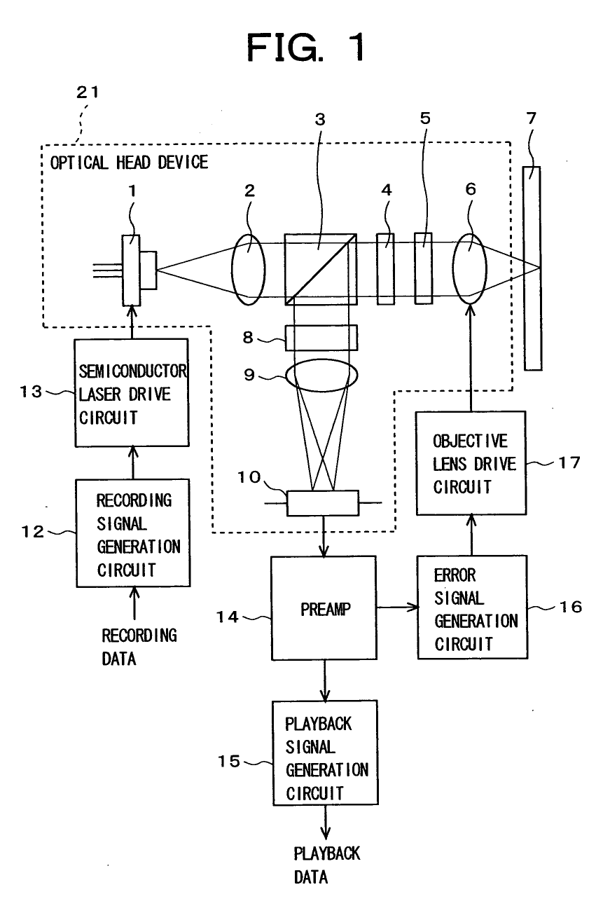

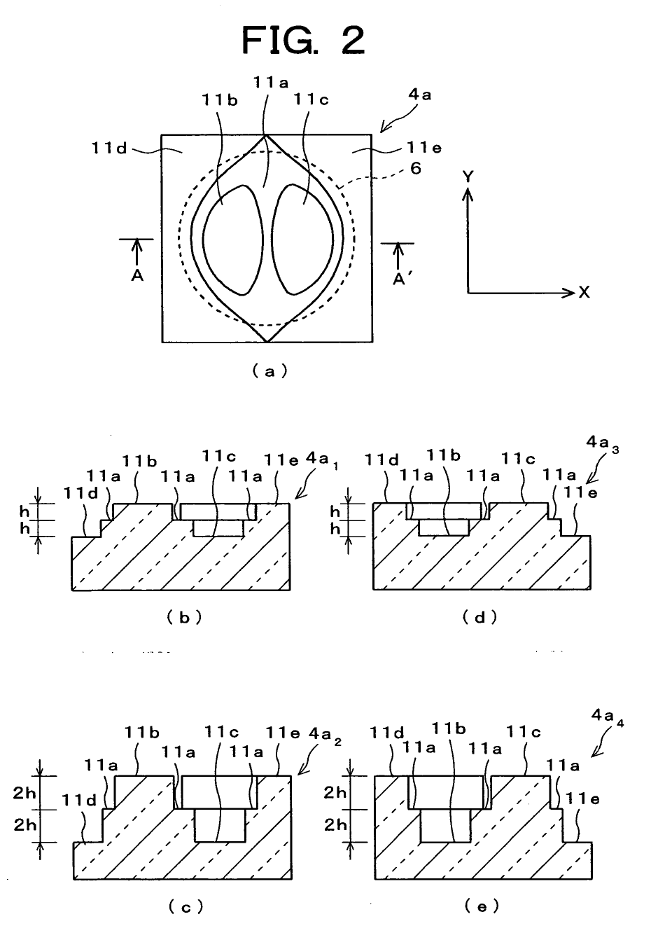

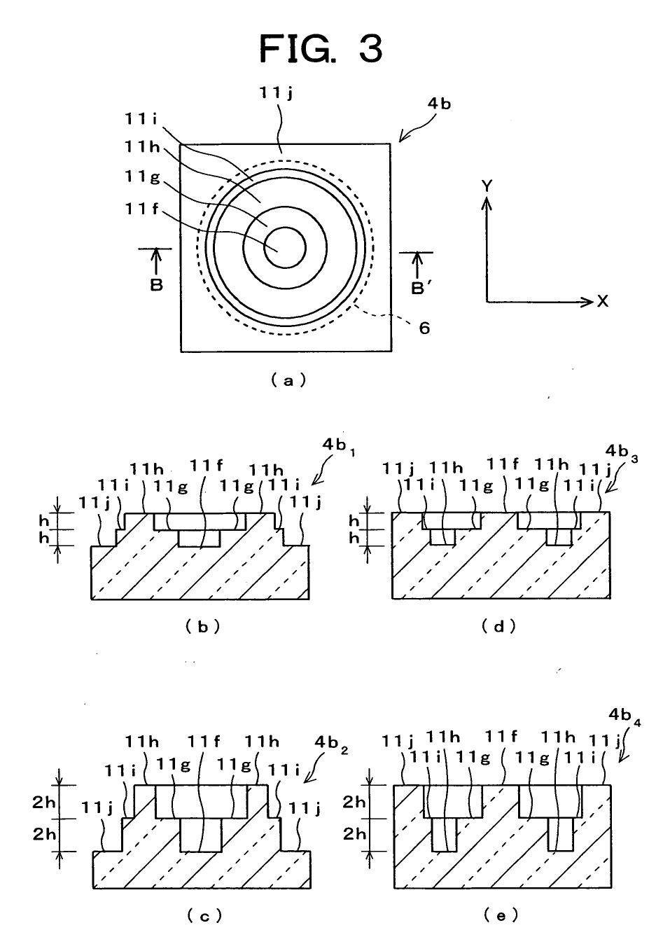

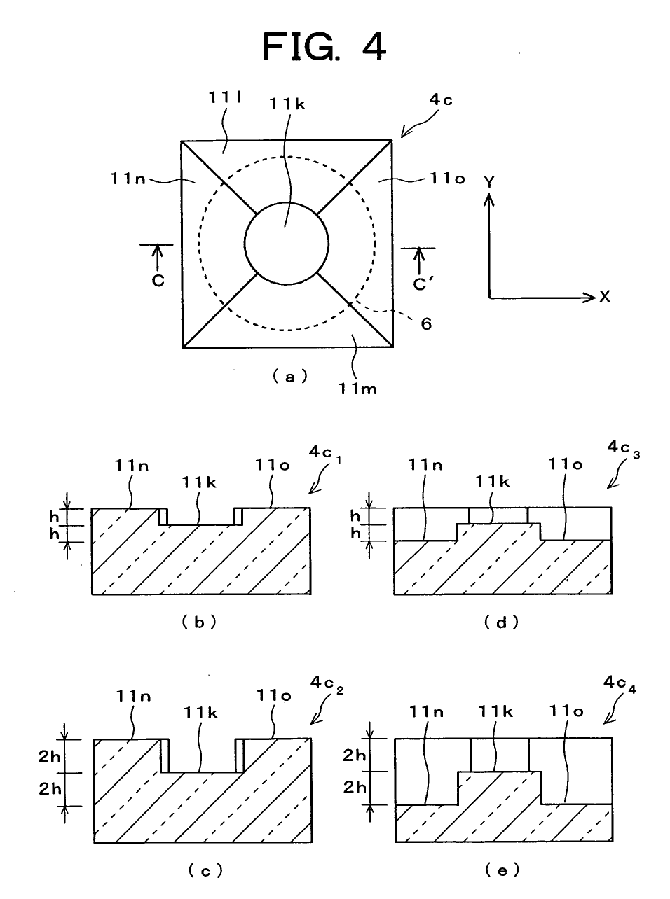

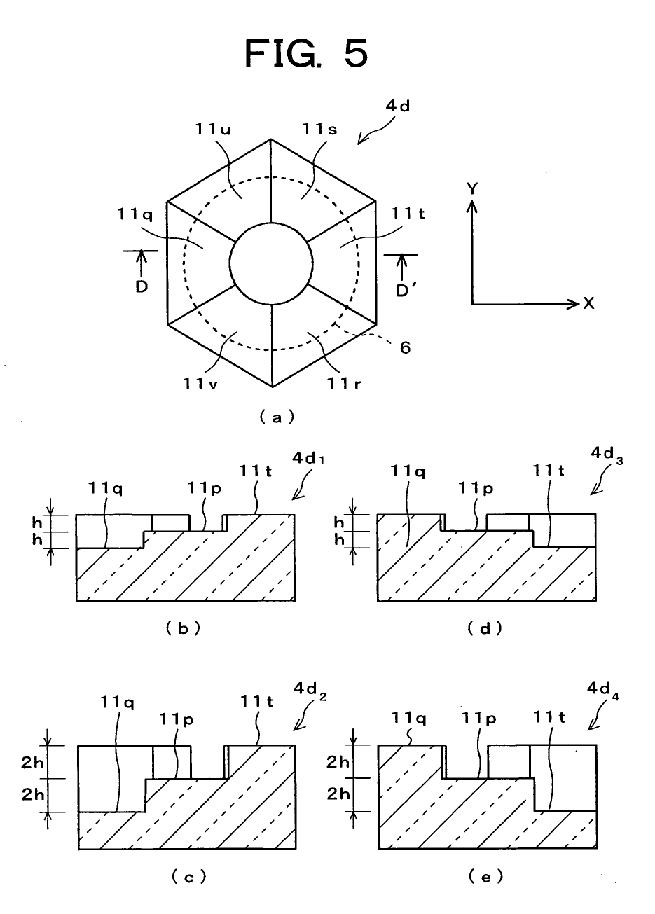

As follows is a more specific description of embodiments of the present invention, with reference to the appended drawings. First, a first embodiment of the present invention will be described. FIG. 1 is a block diagram showing an optical information recording and playback apparatus according to this first embodiment, FIG. 2(a) to FIG. 2(e), FIG. 3(a) to FIG. 3(e), FIG. 4(a) to FIG. 4(e), and FIG. 5(a) to FIG. 5(e) are diagrams showing aberration correction optical elements for incorporation within the optical head device of this optical information recording and playback apparatus, wherein each of the (a) figures is a plan view, and the corresponding figures from (b) through (e) are cross-sectional views. The optical information recording and playback apparatus according to the present embodiment represents, for example, a DVD (Digital Versatile Disc) drive.

As shown in FIG. 1, the optical information recording and playback apparatus according to the present embodiment incorporates an optical head device 21. This optical head device 21 has a semiconductor laser 1, and in the path of the laser beam emitted from this semiconductor laser 1, a collimator lens 2 for collimating the laser beam emitted from the semiconductor laser 1 and forming a parallel beam, a polarization beam splitter 3 which transmits P-polarized light and reflects S-polarized light in a predetermined direction, an aberration correction optical element 4 for correcting optical system aberration, a ¼ wavelength plate 5 which, when irradiated with linearly polarized light beams oscillating in perpendicular directions each other, applies a ¼ wavelength phase difference to the two beams, and an objective lens 6 for converging the incident parallel light beam are disposed. And, a disc 7 that functions as an optical recording medium is positioned at the focus of this objective lens 6.

Furthermore, in the path of the light beam reflected by the polarization beam splitter 3, a cylindrical lens 8, a lens 9, and a photodetector 10 are disposed. The cylindrical lens 8 and the lens 9 constitute a compound lens for imparting astigmatism to the light beam. The photodetector 10 is positioned at the midpoint of the two focal lines formed by the compound lens consisting of the cylindrical lens 8 and the lens 9. A plurality of photoreceptor sections (not shown in the figure) are arranged on the light receiving surface of the photodetector 10, and by measuring the intensity of the incident light at each of these photoreceptor sections, a variety of signals can be detected from the incident light beam.

As shown in FIG. 1, a recording signal generation circuit 12, which generates recording signals for driving the semiconductor laser 1 based on externally input recording data, is provided outside the optical head device 21 of the optical information recording and playback apparatus according to the present embodiment. Furthermore, a semiconductor laser drive circuit 13, into which is input the recording signal output from the recording signal generation circuit 12, and which generates a drive signal for driving the semiconductor laser 1 based on this recording signal and then outputs this drive signal to the semiconductor laser 1, is also provided.

In addition, a preamp 14, which converts the current signal output from the photodetector 10 into a voltage signal, and a playback signal generation circuit 15, which generates a playback signal and outputs playback data externally based on the voltage signal output from the preamp 14, are also provided. Furthermore, an error signal generation circuit 16 is provided for generating a focus error signal and a tracking error signal for driving the objective lens 6 based on the voltage signal output from the preamp 14. An objective lens drive circuit 17, into which is input the focus error signal and the tracking error signal, and which generates a drive signal based on these signals, and an actuator (not shown in the figure), into which is input the drive signal output from the objective lens drive circuit 17, and which controls the position of the objective lens 6, are also provided. In addition, in the optical information recording and playback apparatus according to the present embodiment, other circuits such as a spindle control circuit for rotating the disc 7 and a positioner control circuit for moving the entire optical head device 21 in relation to the disc 7 are also provided.

As described above, the aberration correction optical element 4 is disposed within the path of the light beam between the semiconductor laser 1 and the objective lens 6. In FIG. 1, the aberration correction optical element 4 is inserted between the polarization beam splitter 3 and the ¼ wavelength plate 5, but any position within the optical system between the semiconductor laser 1 and the objective lens 6 is suitable. Furthermore, the aberration correction optical element 4 has one or more aberration correction optical elements selected from the plurality of different aberration correction optical elements described below, and those aberration correction optical elements that are capable of most effectively correcting the aberration generated within the optical head device 21 are selected and incorporated within the optical head device 21. As follows is a detailed description of the plurality of aberration correction optical elements that can be used as the aberration correction optical element 4 for incorporation within the optical head device 21.

In those cases where coma that occurs in the optical system requires correction, an aberration correction optical element 4a shown in FIG. 2 is used as the aberration correction optical element 4. FIG. 2(a) is a plan view showing this aberration correction optical element 4a. As shown in FIG. 2(a), the aberration correction optical element 4a is divided into 5 regions 11a to 11e. In the figure, the broken line corresponds with the effective area for the objective lens 6.

This aberration correction optical element 4a has a region 11a formed from convex curves, the outside edges of which bulge out in the +X and −X directions, and the tips of this region 11a in opposite Y directions extend beyond the effective area of the objective lens 6, and contact the respective outside edges of the aberration correction optical element 4a. Furthermore, the two sides of the region 11a in the respective X directions form the regions 11d and 11e respectively. In addition, two regions 11b and 11c that are symmetrical relative to a center line that lies parallel with the Y axis of the region 11a are provided inside the region 11a.

The aberration correction optical element 4a can be further classified into 4 different types of aberration correction optical element 4a₁ to 4a₄ depending on the amount and/or sign of the coma correction. FIG. 2(b) through FIG. 2(e) are cross-sectional views taken along the line A-A′ in FIG. 2(a), showing 4 types of aberration correction optical element 4a₁ to 4a₄ with differing amounts and/or signs for the coma correction. As shown in FIG. 2(b) to 2(e), the surface shape of each of the aberration correction optical elements 4a₁ to 4a₄ is formed in steps at 3 different levels.

In the aberration correction optical element 4a₁ shown in FIG. 2(b), the respective heights of the regions 11b and 11e are higher than that of the region 11a by a value h, and the respective heights of the regions 11c and 11d are lower than that of the region 11a by the same value h. In the aberration correction optical element 4a₂ shown in FIG. 2(c), the respective heights of the regions 11b and 11e are higher than that of the region 11a by a value 2h, and the respective heights of the regions 11c and 11d are lower than that of the region 11a by the same value 2h. In the aberration correction optical element 4a₃ shown in FIG. 2(d), the respective heights of the regions 11b and 11e are lower than that of the region 11a by the value h, and the respective heights of the regions 11c and 11d are higher than that of the region 11a by the same value h. In the aberration correction optical element 4a₄ shown in FIG. 2(e), the respective heights of the regions 11b and 11e are lower than that of the region 11a by a value 2h, and the respective heights of the regions 11c and 11d are higher than that of the region 11a by the same value 2h. In contrast, the cross-section through the center of the aberration correction optical element 4a in the Y direction is flat.

An aberration correction optical element 4a with this type of cross-sectional shape can be prepared either by molding glass or plastic, or by depositing a dielectric material onto a sheet of glass. The latter preparation method can utilize photolithography processes, and consequently offers lower production costs and superior suitability to mass production.

In those cases where spherical aberration that occurs in the optical system requires correction, an aberration correction optical element 4b shown in FIG. 3 is used as the aberration correction optical element 4. FIG. 3(a) is a plan view showing this aberration correction optical element 4b. As shown in FIG. 3(a), the aberration correction optical element 4b is divided into 5 regions 11f to 11j. In the figure, the broken line corresponds with the effective area for the objective lens 6.

In the aberration correction optical element 4b, a circular region 11f is provided with a center that is concentric with the center of the aberration correction optical element 4b, and annular regions 11g, 11h, and 11i that are concentric with the region 11f are provided from inside to outside around the periphery of the region 11f. The area outside the region 11i of the aberration correction optical element 4b is deemed the region 11j. The outer edge of the region 11i is positioned inside the region that corresponds with the effective area of the objective lens 6.

The aberration correction optical element 4b can be further classified into 4 different types of aberration correction optical element 4b₁ to 4b₄ depending on the amount and/or sign of the spherical aberration correction. FIG. 3(b) through FIG. 3(e) are cross-sectional views taken along the line B-B′ in FIG. 3(a), showing 4 types of aberration correction optical element 4b₁ to 4b₄ with differing amounts and/or signs for the spherical aberration correction. As shown in FIG. 3(b) to 3(e), the surface shape of each of the aberration correction optical elements 4b₁ to 4b₄ is formed in steps at 3 different levels.

In the aberration correction optical element 4b₁ shown in FIG. 3(b), the height of the region 11h is higher than that of the regions 11g and 11i by a value h, and the respective heights of the regions 11f and 11j are lower than those of the regions 11g and 11i by the same value h. In the aberration correction optical element 4b₂ shown in FIG. 3(c), the height of the region 11h is higher than that of the regions 11g and 11i by a value 2h, and the respective heights of the regions 11f and 11j are lower than those of the regions 11g and 11i by the same value 2h. In the aberration correction optical element 4b₃ shown in FIG. 3(d), the height of the region 11h is lower than that of the regions 11g and 11i by the value h, and the respective heights of the regions 11f and 11j are higher than those of the regions 11g and 11i by the same value h. In the aberration correction optical element 4b₄ shown in FIG. 3(e), the height of the region 11h is lower than that of the regions 11g and 11i by a value 2h, and the respective heights of the regions 11f and 11j are higher than those of the regions 11g and 11i by the same value 2h. On the other hand, the cross-section through the center of the aberration correction optical element 4b in the Y direction is identical with the cross-section through the center in the X direction.

An aberration correction optical element 4b with this type of cross-sectional shape can be prepared either by molding glass or plastic, or by depositing a dielectric material onto a sheet of glass. The latter preparation method can utilize photolithography processes, and consequently offers lower production costs and superior suitability to mass production.

In those cases where astigmatism that occurs in the optical system requires correction, an aberration correction optical element 4c shown in FIG. 4 is used as the aberration correction optical element 4. FIG. 4(a) is a plan view showing this aberration correction optical element 4c. As shown in FIG. 4(a), the aberration correction optical element 4c is divided into 5 regions 11k to 11o. In the figure, the broken line corresponds with the effective area for the objective lens 6.

In the aberration correction optical element 4c, a circular region 11k is provided with a center that is concentric with the center of the aberration correction optical element 4c, and the regions 11l to 11o are provided outside this-central region 11k, with four-fold symmetry relative to the center of the aberration correction optical element 4c. Viewed from the region 11k, the region 11l is provided in the +Y direction, the region 11m is provided in the −Y direction, the region 11n is provided in the −X direction, and the region 11o is provided in the +X direction. The mutual boundary lines between the regions 11l to 11o correspond with the diagonals of the aberration correction optical element 4c. The region 11k is positioned within the effective area of the objective lens 6.

The aberration correction optical element 4c can be further classified into 4 different types of aberration correction optical element 4c₁ to 4c₄ depending on the amount and/or sign of the astigmatism correction. FIG. 4(b) through FIG. 4(e) are cross-sectional views taken along the line C-C′ in FIG. 4(a), showing 4 types of aberration correction optical element 4c₁ to 4c₄ with differing amounts and/or signs for the astigmatism correction. As shown in FIG. 4(b) to 4(e), the cross-sectional shape through the center of each of the aberration correction optical elements 4c₁ to 4c₄ in the X direction is stepped at 2 different levels.

In the aberration correction optical element 4c₁ shown in FIG. 4(b), the respective heights of the regions 11n and 11o are higher than that of the region 11k by a value h. In the aberration correction optical element 4c₂ shown in FIG. 4(c), the respective heights of the regions 11n and 11o are higher than that of the region 11k by a value 2h. In the aberration correction optical element 4c₃ shown in FIG. 4(d), the respective heights of the regions 11n and 11o are lower than that of the region 11k by a value h. In the aberration correction optical element 4c₄ shown in FIG. 4(e), the respective heights of the regions 11n and 11o are lower than that of the region 11k by a value 2h.

On the other hand, the cross-sectional shape through the center of the aberration correction optical element 4c in the Y direction (not shown in the figures) is also stepped at 2 different levels. In the aberration correction optical element 4c₁ shown in FIG. 4(b), the respective heights of the regions 11l and 11m are lower than that of the region 11k by a value h. In the aberration correction optical element 4c₂ shown in FIG. 4(c), the respective heights of the regions 11l and 11m are lower than that of the region 11k by a value 2h. In the aberration correction optical element 4c₃ shown in FIG. 4(d), the respective heights of the regions 11l and 11m are higher than that of the region 11k by a value h. In the aberration correction optical element 4c₄ shown in FIG. 4(e), the respective heights of the regions 11l and 11m are higher than that of the region 11k by a value 2h. In other words, the overall cross-sectional shape of the aberration correction optical element 4c is formed in steps at 3 different levels.

An aberration correction optical element 4c with this type of cross-sectional shape can be prepared either by molding glass or plastic, or by depositing a dielectric material onto a sheet of glass. The latter preparation method can utilize photolithography processes, and consequently offers lower production costs and superior suitability to mass production.

In those cases where arrow aberration that occurs in the optical system requires correction, an aberration correction optical element 4d shown in FIG. 5 is used as the aberration correction optical element 4. FIG. 5(a) is a plan view showing this aberration correction optical element 4d. As shown in FIG. 5(a), the overall shape of the aberration correction optical element 4d is a regular hexagon when viewed along the optical axis. Moreover, the aberration correction optical element 4d is divided into 7 regions 11p to 11v. In the figure, the broken line corresponds with the effective area for the objective lens 6.

In the aberration correction optical element 4d, a circular region 11p is provided with a center that is concentric with the center of the aberration correction optical element 4d, and the regions 11q to 11v are provided outside this central region lip, with six-fold symmetry relative to the center of the aberration correction optical element 4d. Viewed from the region 11p, the region 11q is provided in the −X direction, the region 11r is provided in a direction inclined 60° towards the −Y direction from the +X direction, the region 11s is provided in a direction inclined 60° towards the +Y direction from the +X direction, the region 11t is provided in the +X direction, the region 11u is provided in a direction inclined 60° towards the +Y direction from the −X direction, and the region 11v is provided in a direction inclined 60° towards the −Y direction from the −X direction. In other words, the region 11s, the region 11t, the region 11r, the region 11v, the region 11q, and the region 11u encircle the circular region 11p in this order. The mutual boundary lines between the regions 11q to 11v correspond with the diagonals of the aberration correction optical element 4d. The region 11p is positioned within the effective area of the objective lens 6.

The aberration correction optical element 4d can be further classified into 4 different types of aberration correction optical element 4d₁ to 4d₄ depending on the amount and/or sign of the arrow aberration correction. FIG. 5(b) through FIG. 5(e) are cross-sectional views taken along the line D-D′ in FIG. 5(a), showing 4 types of aberration correction optical element 4d₁ to 4d₄ with differing amounts and/or signs for the arrow aberration correction. As shown in FIG. 5(b) to 5(e), the cross-sectional shape through the center of each of the aberration correction optical elements 4d₁ to 4d₄ in the X direction is stepped at 3 different levels.

In the aberration correction optical element 4d, shown in FIG. 5(b), the height of the region 11q is lower than that of the region 11p by a value h, and the height of the region 11t is higher than that of the region 11p by the same value h. In the aberration correction optical element 4d₂ shown in FIG. 5(c ), the height of the region 11q is lower than that of the region 11p by a value 2h, and the height of the region 11t is higher than that of the region 11p by the same value 2h. In the aberration correction optical element 4d₃ shown in FIG. 5(d), the height of the region 11q is higher than that of the region 11p by a value h, and the height of the region 11t is lower than that of the region 11p by the same value h. In the aberration correction optical element 4d₄ shown in FIG. 5(e), the height of the region 11q is higher than that of the region 11p by a value 2h, and the height of the region 11t is lower than that of the region 11p by the same value 2h.

On the other hand, the shape (not shown in the figures) of the aberration correction optical element 4d in a cross-section through the center of the element in a direction parallel to a direction inclined 60° towards the −Y direction from the +X direction is also stepped at 3 different levels, in a similar manner to the cross-section in the X direction. In the aberration correction optical element 4d₁ shown in FIG. 5(b), the height of the region 11r is lower than that of the region 11p by a value h, and the height of the region 11u is higher than that of the region 11p by the same value h. In the aberration correction optical element 4d₂ shown in FIG. 5(c ), the height of the region 11r is lower than that of the region 11p by a value 2h, and the height of the region 11u is higher than that of the region 11p by the same value 2h. In the aberration correction optical element 4d₃ shown in FIG. 5(d), the height of the region 11r is higher than that of the region 11p by a value h, and the height of the region 11u is lower than that of the region 11p by the same value h. In the aberration correction optical element 4d₄ shown in FIG. 5(e), the height of the region 11r is higher than that of the region 11p by a value 2h, and the height of the region 11u is lower than that of the region 11p by the same value 2h.

Furthermore, the shape (not shown in the figures) of the aberration correction optical element 4d in a cross-section through the center of the element in a direction parallel to a direction inclined 60° towards the +Y direction from the +X direction is also stepped at 3 different levels, in a similar manner to the cross-section in the X direction. In the aberration correction optical element 4d₁ shown in FIG. 5(b), the height of the region 11s is lower than that of the region 11p by a value h, and the height of the region 11v is higher than that of the region 11p by the same value h. In the aberration correction optical element 4d₂ shown in FIG. 5(c ), the height of the region 11s is lower than that of the region 11p by a value 2h, and the height of the region 11v is higher than that of the region 11p by the same value 2h. In the aberration correction optical element 4d₃ shown in FIG. 5(d), the height of the region 11s is higher than that of the region 11p by a value h, and the height of the region 11v is lower than that of the region 11p by the same value h. In the aberration correction optical element 4d₄ shown in FIG. 5(e), the height of the region 11s is higher than that of the region 11p by a value 2h, and the height of the region 11v is lower than that of the region 11p by the same value 2h.

An aberration correction optical element 4d with this type of cross-sectional shape can be prepared either by molding glass or plastic, or by depositing a dielectric material onto a sheet of glass. The latter preparation method can utilize photolithography processes, and consequently offers lower production costs and superior suitability to mass production.

Next is a description of a method of manufacturing an optical head device 21 according to the present embodiment. First, as shown in FIG. 1, a semiconductor laser 1, a collimator lens 2, a polarization beam splitter 3, a ¼ wavelength plate 5, and an objective lens 6 are arranged, in that order, in the path of the laser beam emitted from the semiconductor laser 1, thereby forming an optical system. Furthermore, a cylindrical lens 8, a lens 9, and a photodetector 10 are arranged, in that order, in the path of the light beam that is reflected by the polarization beam splitter 3. Meanwhile, the aforementioned aberration correction optical elements 4a₁ to 4a₄, 4b₁ to 4b₄, 4c₁ to 4c₄, and 4d₁ to 4d₄ are prepared for use as the aberration correction optical element.

Subsequently, the aberration of the light beam within the optical path including the semiconductor laser 1, the collimator lens 2, the polarization beam splitter 3, the ¼ wavelength plate 5, and the objective lens 6 is measured using an interferometer or the like. Based on the type of aberration, and the sign and amount of the aberration, either one, or a plurality of aberration correction optical elements capable of correcting the measured aberration are selected from amongst the aberration correction optical elements 4a₁ to 4a₄, 4b₁ to 4b₄, 4c₁ to 4c₄, and 4d₁ to 4d₄, and the selected aberration correction optical element (or elements) 4 is placed in the optical path, in a position between the polarization beam splitter 3 and the ¼ wavelength plate 5. At this point, the aberration correction optical element 4 may be rotated around the optical axis of the incident light beam to adjust the direction of the aberration correction optical element 4 so that the direction of the aberration corrected by the aberration correction optical element 4 matches the direction of the measured aberration. This completes the manufacture of the optical head device 21.

Next is a description of the operation of an optical information recording and playback apparatus of the present embodiment constructed in the manner described above. First is a description of the operation of recording to the optical disc 7. As shown in FIG. 1, first, external recording data is input into the recording signal generation circuit 12. Then, based on this input recording data, the recording signal generation circuit 12 generates a recording signal for driving the semiconductor laser 1, and then outputs this signal to the semiconductor laser drive circuit 13. Based on this recording signal, the semiconductor laser drive circuit 13 generates a drive signal, which it outputs to the semiconductor laser 1 of the optical head device 21.

The semiconductor laser 1 then emits a laser beam in accordance with the received drive signal. This laser beam is collimated and converted to a parallel beam by the collimator lens 2, is subsequently irradiated onto the polarization beam splitter 3 as P-polarized light and is substantially transmitted, and then passes through the aberration correction optical element 4, which corrects the aberration within the onward optical path. The light beam then passes through the ¼ wavelength plate 5 and undergoes conversion from linearly polarized light to circularly polarized light, and is focused onto the surface of the disc 7 by the objective lens 6. This process enables the data to be written onto the disc 7, thus recording the signal.

The light beam is then reflected off the surface of the disc 7, passes through the objective lens 6 in the opposite direction, passes through the ¼ wavelength plate 5 and undergoes conversion from circularly polarized light to linearly polarized light in which the direction of polarization is perpendicular to that of the light beam within the onward optical path, passes through the aberration correction optical element 4, thus correcting the aberration within the return path, and is subsequently irradiated onto the polarization beam splitter 3 as S-polarized light where it is substantially reflected and directed towards the cylindrical lens 8. Astigmatism is applied to the light beam by transmission through the cylindrical lens 8 and the lens 9, and the beam then enters the photodetector 10. An electrical current signal is generated based on the intensity of the incident light at each of the photoreceptor sections of the photodetector 10, and this current signal is output to the preamp 14.

Subsequently, as shown in FIG. 1, the preamp 14 converts the received electrical current signal into a voltage signal, which it then outputs to the playback signal generation circuit 15 and the error signal generation circuit 16. Based on this voltage signal received from the preamp 14, the error signal generation circuit 16 generates a focus error signal and a tracking error signal for driving the objective lens 6.

The objective lens drive circuit 17 then drives an actuator based on the focus error signal and tracking error signal received from the error signal generation circuit 16, thereby controlling the position of the objective lens 6. This enables focus servo and tracking servo operations to be conducted.

Next is a description of the operation for playback from the optical disc 7. During playback of data, the semiconductor laser drive circuit 13 does not drive the semiconductor laser 1 based on externally input recording data, but rather causes the semiconductor laser 1 to output a constant laser beam. Then, in a similar manner to the recording operation described above, this laser beam is focused onto, and then reflected off, the optical disc 7, and is received by the photodetector 10 as an electrical current signal. Subsequently, the preamp 14 converts this electrical current signal into a voltage signal, which it then outputs to the playback signal generation circuit 15 and the error signal generation circuit 16.

The playback signal generation circuit 15 then generates a playback signal based on the voltage signal received from the preamp 14, and outputs this signal externally as playback data. This process enables the playback of signals from the disc 7. Operation of the error signal generation circuit 16, the objective lens drive circuit 17, and the actuator are the same as described above for data recording.

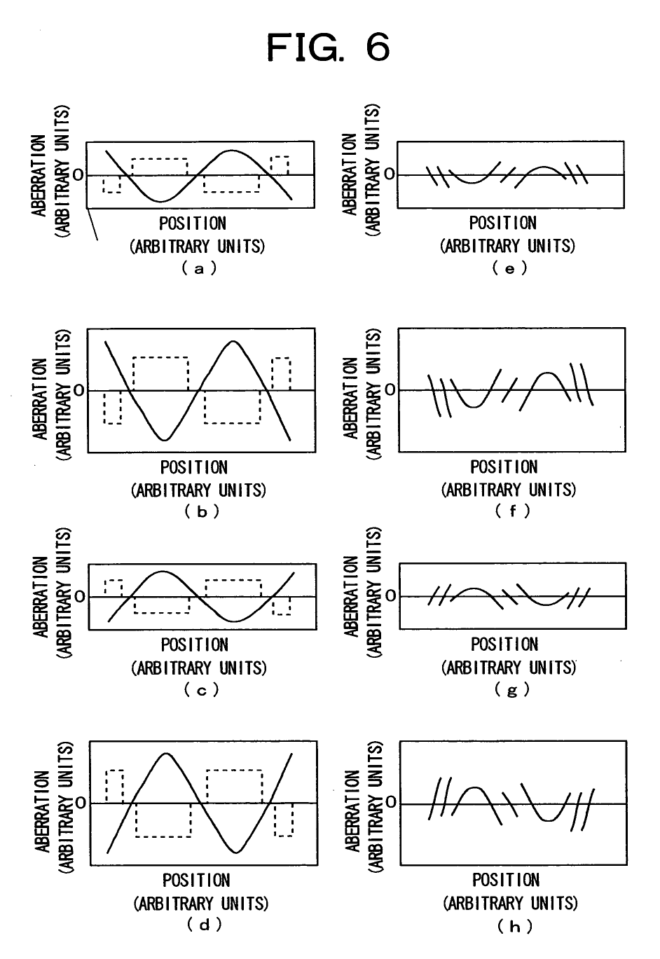

As follows is a detailed description of the action of the aberration correction optical element 4 during operation of the optical information recording and playback apparatus described above. FIG. 6(a) through FIG. 6(h) are graphs showing the wave-front aberration for the optical system or the aberration correction optical element 4a, wherein the horizontal axis represents the position along the cross-section in the X direction that passes through the center of the aberration correction optical element 4a, and the vertical axis represents the amount of aberration. The solid lines shown in FIG. 6(a) through FIG. 6(d) represent coma that is generated within the optical system, and the broken lines represent the wave-front aberration generated by the aberration correction optical element 4a, whereas the solid lines shown in FIG. 6(e) through FIG. 6(h) represent the wave-front aberration when the coma generated within the optical system is corrected using the aberration correction optical element 4a.

In FIG. 6(a), the coma generated within the optical system varies from positive to negative, to positive, and back to negative again in moving from negative to positive along the X axis, and the RMS (root mean square) wave-front aberration is 0.02 λ. In order to correct this coma, the aberration correction optical element 4a₁ shown in FIG. 2(b) is used. The coma generated by the aberration correction optical element 4a₁ varies from negative to positive, to negative, and back to positive again in moving from negative to positive along the X axis. The height h in FIG. 2(b) is designed so that when the aberration correction optical element 4a₁ is used to correct the coma shown in FIG. 6(a), the residual RMS wave-front aberration is minimized. FIG. 6(e) shows this residual wave-front aberration, namely, the sum of the solid line and the broken line shown in FIG. 6(a), and it is evident that the absolute value of the residual wave-front aberration is approaching 0 λ.

In FIG. 6(b), the coma generated within the optical system varies from positive to negative, to positive, and back to negative again in moving from negative to positive along the X axis, and the RMS wave-front aberration is 0.04 λ. In order to correct this coma, the aberration correction optical element 4a₂ shown in FIG. 2(c) is used. The coma generated by the aberration correction optical element 4a₂ varies from negative to positive, to negative, and back to positive again in moving from negative to positive along the X axis. The height 2h in FIG. 2(c) is designed so that when the aberration correction optical element 4a₂ is used to correct the coma shown in FIG. 6(b), the residual RMS wave-front aberration is minimized. FIG. 6(f) shows this residual wave-front aberration, namely, the sum of the solid line and the broken line shown in FIG. 6(b), and it is evident that the absolute value of the residual wave-front aberration is approaching 0 λ.

In FIG. 6(c), the coma generated within the optical system varies from negative to positive, to negative, and back to positive again in moving from negative to positive along the X axis, and the RMS wave-front aberration is 0.02 λ. In order to correct this coma, the aberration correction optical element 4a₃ shown in FIG. 2(d) is used. The coma generated by the aberration correction optical element 4a₃ varies from positive to negative, to positive, and back to negative again in moving from negative to positive along the X axis. The height h in FIG. 2(d) is designed so that when the aberration correction optical element 4a₃ is used to correct the coma shown in FIG. 6(c), the residual RMS wave-front aberration is minimized. FIG. 6(g) shows this residual wave-front aberration, namely, the sum of the solid line and the broken line shown in FIG. 6(c), and it is evident that the absolute value of the residual wave-front aberration is approaching 0λ.

In FIG. 6(d), the coma generated within the optical system varies from negative to positive, to negative, and back to positive again in moving from negative to positive along the X axis, and the RMS wave-front aberration is 0.04 λ. In order to correct this coma, the aberration correction optical element 4a₄ shown in FIG. 6(e) is used. The coma generated by the aberration correction optical element 4a₄ varies from positive to negative, to positive, and back to negative again in moving from negative to positive along the X axis. The height 2h in FIG. 2(e) is designed so that when the aberration correction optical element 4a₄ is used to correct the coma shown in FIG. 6(d), the residual RMS wave-front aberration is minimized. FIG. 6(h) shows this residual wave-front aberration, namely, the sum of the solid line and the broken line shown in FIG. 6(d), and it is evident that the absolute value of the residual wave-front aberration is approaching 0λ.

In contrast, the wave-front aberration in the cross-section through the center of the aberration correction optical element 4a in the Y direction is 0 λ.

The coma generated within the optical system is assumed to have a maximum RMS wave-front aberration of 0.05 λ. Based on this assumption, the four different aberration correction optical elements 4a shown in FIG. 2(b) through FIG. 2(e) are prepared in advance. Then, the amount and sign of the coma that is generated within the optical system, except the aberration correction optical element 4a, between the semiconductor laser 1 and the objective lens 6, is measured using an interferometer or the like. Based on the measured amount and sign of the coma, where necessary, the aberration correction optical element 4a which, following correction, is most capable of minimizing the residual RMS wave-front aberration is selected from amongst the four different aberration correction optical elements 4a1 to 4a4, and is then inserted into the optical system. Specifically, if the RMS wave-front aberration is no more than 0.01 λ, then coma correction using an aberration correction optical element 4a is not required. If the RMS wave-front aberration is greater than 0.01 λ but no more than 0.03 λ, then coma correction is conducted using either the aberration correction optical element 4a₁ shown in FIG. 2(b) or the aberration correction optical element 4a₃ shown in FIG. 2(d), depending on the sign of the coma. This enables the residual RMS wave-front aberration following correction to be reduced to approximately 0.01 λ or less. If the RMS wave-front aberration is greater than 0.03 λ but no more than 0.05 λ, then coma correction is conducted using either the aberration correction optical element 4a₂ shown in FIG. 2(c) or the aberration correction optical element 4a₄ shown in FIG. 2(e), depending on the sign of the coma. This enables the residual RMS wave-front aberration following correction to be reduced to approximately 0.01 λ or less. In the present embodiment, the number of different aberration correction optical elements 4a was set to 4, but increasing the variety of aberration correction optical elements 4a in terms of the amount and/or sign of the coma correction enables the residual RMS wave-front aberration following correction to be further reduced.

In FIG. 2 through FIG. 6, the description focused on cases in which the direction of the coma generated in the optical system was within the X direction, but even in cases where the coma generated in the optical system is not within the X direction, coma correction can still be achieved by rotating the aberration correction optical element 4a within the plane perpendicular to the optical axis of the incident light, so that the direction of the coma in the optical system can be substantially matched with the direction of the coma correction provided by the aberration correction optical element 4a.

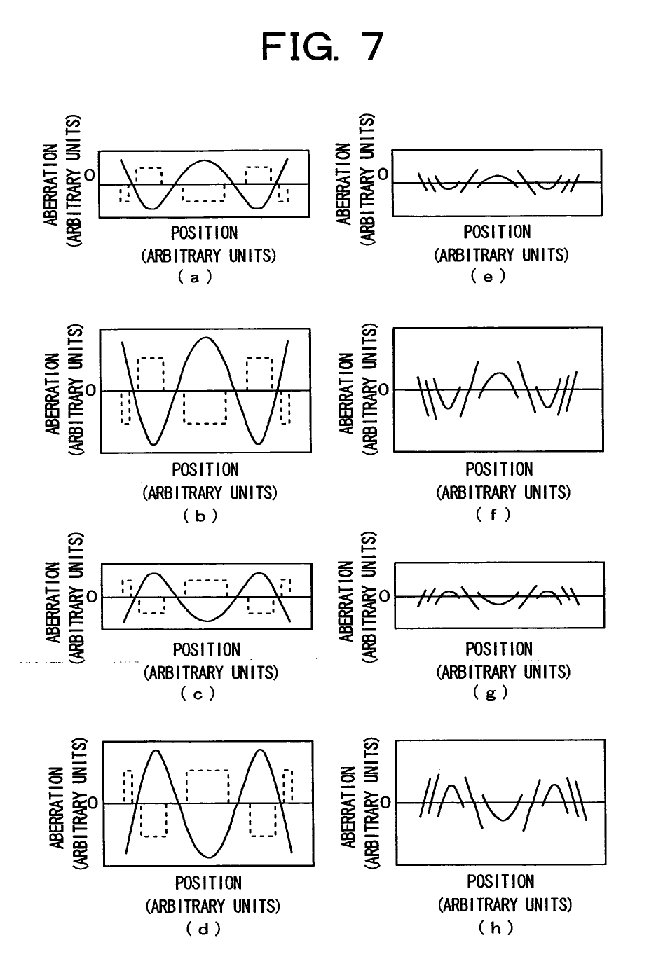

FIG. 7(a) through FIG. 7(h) are graphs showing the wave-front aberration for the optical system or the aberration correction optical element 4b, wherein the horizontal axis represents the position along the cross-section in the X direction that passes through the center of the aberration correction optical element 4b, and the vertical axis represents the amount of aberration. The solid lines shown in FIG. 7(a) through FIG. 7(d) represent spherical aberration that is generated within the optical system, and the broken lines represent the wave-front aberration generated by the aberration correction optical element 4b, whereas the solid lines shown in FIG. 7(e) through FIG. 7(h) represent the wave-front aberration when the spherical aberration generated within the optical system is corrected using the aberration correction optical element 4b.

In FIG. 7(a), the spherical aberration generated within the optical system varies from positive to negative, to positive, to negative, and back to positive again in moving from negative to positive along the X axis, and the RMS wave-front aberration is 0.02 λ. In order to correct this spherical aberration, the aberration correction optical element 4b₁ shown in FIG. 3(b) is used. The spherical aberration generated by the aberration correction optical element 4b₁ varies from negative to positive, to negative, to positive, and back to negative again in moving from negative to positive along the X axis. The height h in FIG. 3(b) is designed so that when the aberration correction optical element 4b₁ is used to correct the spherical aberration shown in FIG. 7(a), the residual RMS wave-front aberration is minimized. FIG. 7(e) shows this residual wave-front aberration, namely, the sum of the solid line and the broken line shown in FIG. 7(a), and it is evident that the absolute value of the residual wave-front aberration is approaching 0λ.

In FIG. 7(b), the spherical aberration generated within the optical system varies from positive to negative, to positive, to negative, and back to positive again in moving from negative to positive along the X axis, and the RMS wave-front aberration is 0.04 λ. In order to correct this spherical aberration, the aberration correction optical element 4b₂ shown in FIG. 3(c) is used. The spherical aberration generated by the aberration correction optical element 4b₂ varies from negative to positive, to negative, to positive, and back to negative again in moving from negative to positive along the X axis. The height 2h in FIG. 3(c) is designed so that when the aberration correction optical element 4b₂ is used to correct the spherical aberration shown in FIG. 7(b), the residual RMS wave-front aberration is minimized. FIG. 7(f) shows this residual wave-front aberration, namely, the sum of the solid line and the broken line shown in FIG. 7(b), and it is evident that the absolute value of the residual wave-front aberration is approaching 0 λ.

In FIG. 7(c), the spherical aberration generated within the optical system varies from negative to positive, to negative, to positive, and back to negative again in moving from negative to positive along the X axis, and the RMS wave-front aberration is 0.02 λ. In order to correct this spherical aberration, the aberration correction optical element 4b₃ shown in FIG. 3(d) is used. The spherical aberration generated by the aberration correction optical element 4b₃ varies from positive to negative, to positive, to negative, and back to positive again in moving from negative to positive along the X axis. The height h in FIG. 3(d) is designed so that when the aberration correction optical element 4b₃ is used to correct the spherical aberration shown in FIG. 7(c), the residual RMS wave-front aberration is minimized. FIG. 7(g) shows this residual wave-front aberration, namely, the sum of the solid line and the broken line shown in FIG. 7(c), and it is evident that the absolute value of the residual wave-front aberration is approaching 0 λ.

In FIG. 7(d), the spherical aberration generated within the optical system varies from negative to positive, to negative, to positive, and back to negative again in moving from negative to positive along the X axis, and the RMS wave-front aberration is 0.04 λ. In order to correct this spherical aberration, the aberration correction optical element 4b₄ shown in FIG. 3(e) is used. The spherical aberration generated by the aberration correction optical element 4b₄ varies from positive to negative, to positive, to negative, and back to positive again in moving from negative to positive along the X axis. The height 2h in FIG. 3(e) is designed so that when the aberration correction optical element 4b₄ is used to correct the spherical aberration shown in FIG. 7(d), the residual RMS wave-front aberration is minimized. FIG. 7(h) shows this residual wave-front aberration, namely, the sum of the solid line and the broken line shown in FIG. 7(d), and it is evident that the absolute value of the residual wave-front aberration is approaching 0 λ.

The wave-front aberration in the cross-section through the center of the aberration correction optical element 4b in the Y direction is the same as the wave-front aberration in the cross-section through the center of the optical element in the X direction.

The spherical aberration generated within the optical system is assumed to have a maximum RMS wave-front aberration of 0.05 λ. Based on this assumption, the four different aberration correction optical elements 4b shown in FIG. 3(b) through FIG. 3(e) are prepared in advance. Then, the amount and sign of the spherical aberration that is generated within the optical system, except the aberration correction optical element 4b, between the semiconductor laser 1 and the objective lens 6, is measured using an interferometer or the like. Based on the measured amount and sign of the spherical aberration, where necessary, the aberration correction optical element 4b which, following correction, is most capable of minimizing, the residual RMS wave-front aberration is selected from amongst the four different aberration correction optical elements 4b, and is then inserted into the optical system. Specifically, if the RMS wave-front aberration is no more than 0.01 λ, then spherical aberration correction using an aberration correction optical element 4b is not required. If the RMS wave-front aberration is greater than 0.01 λ but no more than 0.03 λ, then spherical aberration correction is conducted using either the aberration correction optical element 4b₁ shown in FIG. 3(b) or the aberration correction optical element 4b₃ shown in FIG. 3(d), depending on the sign of the spherical aberration. This enables the residual RMS wave-front aberration following correction to be reduced to approximately 0.01 λ or less. If the RMS wave-front aberration is greater than 0.03 λ but no more than 0.05 λ, then spherical aberration correction is conducted using either the aberration correction optical element 4b₂ shown in FIG. 3(c) or the aberration correction optical element 4b₄ shown in FIG. 3(e), depending on the sign of the spherical aberration. This enables the residual RMS wave-front aberration following correction to be reduced to approximately 0.01 λ or less. In the present embodiment, the number of different aberration correction optical elements 4b was set to 4, but increasing the variety of aberration correction optical elements 4b in terms of the amount and/or sign of the spherical aberration correction enables the residual RMS wave-front aberration following correction to be further reduced.

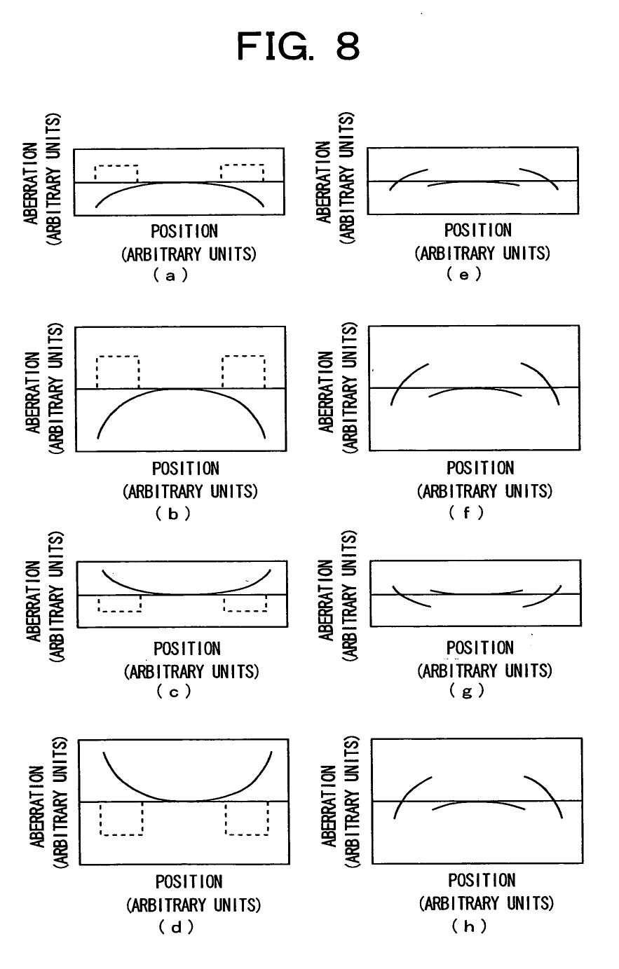

FIG. 8(a) through FIG. 8(h) are graphs showing the wave-front aberration for the optical system or the aberration correction optical element 4c, wherein the horizontal axis represents the position along the cross-section in the X direction that passes through the center of the aberration correction optical element 4c, and the vertical axis represents the amount of aberration. The solid lines shown in FIG. 8(a) through FIG. 8(d) represent astigmatism that is generated within the optical system, and the broken lines represent the wave-front aberration generated by the aberration correction optical element 4c, whereas the solid lines shown in FIG. 8(e) through FIG. 8(h) represent the wave-front aberration when the astigmatism generated within the optical system is corrected using the aberration correction optical element 4c.

In FIG. 8(a), the astigmatism generated within the optical system varies from negative, to zero, and back to negative again in moving from negative to positive along the X axis, and the RMS wave-front aberration is 0.02 λ. In order to correct this astigmatism, the aberration correction optical element 4c₁ shown in FIG. 4(b) is used. The astigmatism generated by the aberration correction optical element 4c₁ varies from positive, to zero, and back to positive again in moving from negative to positive along the X axis. The height h in FIG. 4(b) is designed so that when the aberration correction optical element 4c₁ is used to correct the astigmatism shown in FIG. 8(a), the residual RMS wave-front aberration is minimized. FIG. 8(e) shows this residual wave-front aberration, namely, the sum of the solid line and the broken line shown in FIG. 8(a), and it is evident that the absolute value of the residual wave-front aberration is approaching 0 λ.

In FIG. 8(b), the astigmatism generated within the optical system varies from negative, to zero, and back to negative again in moving from negative to positive along the X axis, and the RMS wave-front aberration is 0.04 λ. In order to correct this astigmatism, the aberration correction optical element 4c₂ shown in FIG. 4(c) is used. The astigmatism generated by the aberration correction optical element 4c₂ varies from positive, to zero, and back to positive again in moving from negative to positive along the X axis. The height 2h in FIG. 4(c) is designed so that when the aberration correction optical element 4c₂ is used to correct the astigmatism shown in FIG. 8(b), the residual RMS wave-front aberration is minimized. FIG. 8(f) shows this residual wave-front aberration, namely, the sum of the solid line and the broken line shown in FIG. 8(b), and it is evident that the absolute value of the residual wave-front aberration is approaching 0 λ.

In FIG. 8(c), the astigmatism generated within the optical system varies from positive, to zero, and back to positive again in moving from negative to positive along the X axis, and the RMS wave-front aberration is 0.02 λ. In order to correct this astigmatism, the aberration correction optical element 4c₃ shown in FIG. 4(d) is used. The astigmatism generated by the aberration correction optical element 4c₃ varies from negative, to zero, and back to negative again in moving from negative to positive along the X axis. The height h in FIG. 4(d) is designed so that when the aberration correction optical element 4c₃ is used to correct the astigmatism shown in FIG. 8(c), the residual RMS wave-front aberration is minimized. FIG. 8(g) shows this residual wave-front aberration, namely, the sum of the solid line and the broken line shown in FIG. 8(c), and it is evident that the absolute value of the residual wave-front aberration is approaching 0λ.

In FIG. 8(d), the astigmatism generated within the optical system varies from positive, to zero, and back to positive again in moving from negative to positive along the X axis, and the RMS wave-front aberration is 0.04 λ. In order to correct this astigmatism, the aberration correction optical element 4c₄ shown in FIG. 4(e) is used. The astigmatism generated by the aberration correction optical element 4c₄ varies from negative, to zero, and back to negative again in moving from negative to positive along the X axis. The height 2h in FIG. 4(e) is designed so that when the aberration correction optical element 4c₄ is used to correct the astigmatism shown in FIG. 8(d), the residual RMS wave-front aberration is minimized. FIG. 8(h) shows this residual wave-front aberration, namely, the sum of the solid line and the broken line shown in FIG. 8(d), and it is evident that the absolute value of the residual wave-front aberration is approaching 0 λ.

The wave-front aberration in the cross-section through the center of the aberration correction optical element 4c in the Y direction has the opposite sign to the wave-front aberration in the cross-section through the center of the optical element in the X direction.

The astigmatism generated within the optical system is assumed to have a maximum RMS wave-front aberration of 0.05 λ. Based on this assumption, the four different aberration correction optical elements 4c shown in FIG. 4(b) through FIG. 4(e) are prepared in advance. Then, the amount and sign of the astigmatism that is generated within the optical system, except the aberration correction optical element 4c, between the semiconductor laser 1 and the objective lens 6, is measured using an interferometer or the like. Based on the measured amount and sign of the astigmatism, where necessary, the aberration correction optical element 4c which, following correction, is most capable of minimizing the residual RMS wave-front aberration is selected from amongst the four different aberration correction optical elements 4c₁ to 4c₄, and is then inserted into the optical system. Specifically, if the RMS wave-front aberration is no more than 0.01 λ, then astigmatism correction using an aberration correction optical element 4c is not required. If the RMS wave-front aberration is greater than 0.01 λ but no more than 0.03 λ, then astigmatism correction is conducted using either the aberration correction optical element 4c₁ shown in FIG. 4(b) or the aberration correction optical element 4c₃ shown in FIG. 4(d), depending on the sign of the astigmatism. This enables the residual RMS wave-front aberration following correction to be reduced to approximately 0.01 λ or less. If the RMS wave-front aberration is greater than 0.03 λ but no more than 0.05 λ, then astigmatism correction is conducted using either the aberration correction optical element 4c₂ shown in FIG. 4(c) or the aberration correction optical element 4c₄ shown in FIG. 4(e), depending on the sign of the astigmatism. This enables the residual RMS wave-front aberration following correction to be reduced to approximately 0.01 λ or less. In the present embodiment, the number of different aberration correction optical elements 4c was set to 4, but increasing the variety of aberration correction optical elements 4c in terms of the amount and/or sign of the astigmatism correction enables the residual RMS wave-front aberration following correction to be further reduced.

In FIG. 4 and FIG. 8, the description focused on cases in which the direction of the astigmatism generated in the optical system was within the X-Y direction, but even in cases where the astigmatism generated in the optical system is not within the X-Y direction, astigmatism correction can still be achieved by rotating the aberration correction optical element 4c within the plane perpendicular to the optical axis of the incident light, so that the direction of the astigmatism in the optical system can be substantially matched with the direction of the astigmatism correction provided by the aberration correction optical element 4c.

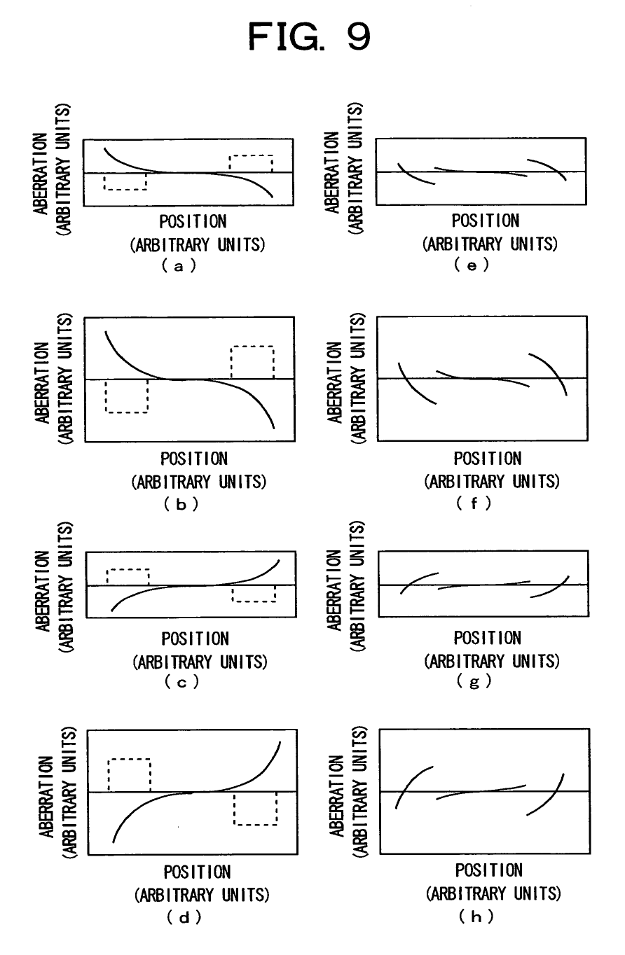

FIG. 9(a) through FIG. 9(h) are graphs showing the wave-front aberration for the optical system or the aberration correction optical element 4d, wherein the horizontal axis represents the position along the cross-section in the X direction that passes through the center of the aberration correction optical element 4d, and the vertical axis represents the amount of aberration. The solid lines shown in FIG. 9(a) through FIG. 9(d) represent arrow aberration that is generated within the optical system, and the broken lines represent the wave-front aberration generated by the aberration correction optical element 4d, whereas the solid lines shown in FIG. 9(e) through FIG. 9(h) represent the wave-front aberration when the arrow aberration generated within the optical system is corrected using the aberration correction optical element 4d.

In FIG. 9(a), the arrow aberration generated within the optical system varies from positive, to zero, and then to negative in moving from negative to positive along the X axis, and the RMS wave-front aberration is 0.02 λ. In order to correct this arrow aberration, the aberration correction optical element 4d₁ shown in FIG. 5(b) is used. The arrow aberration generated by the aberration correction optical element 4d₁ varies from negative, to zero, and then to positive in moving from negative to positive along the X axis. The height h in FIG. 5(b) is designed so that when the aberration correction optical element 4d₁ is used to correct the astigmatism shown in FIG. 9(a), the residual RMS wave-front aberration is minimized. FIG. 9(e) shows this residual wave-front aberration, namely, the sum of the solid line and the broken line shown in FIG. 9(a), and it is evident that the absolute value of the residual wave-front aberration is approaching 0 λ.

In FIG. 9(b), the arrow aberration generated within the optical system varies from positive, to zero, and then to negative in moving from negative to positive along the X axis, and the RMS wave-front aberration is 0.04 λ. In order to correct this arrow aberration, the aberration correction optical element 4d₂ shown in FIG. 5(c ) is used. The arrow aberration generated by the aberration correction optical element 4d₂ varies from negative, to zero, and then to positive in moving from negative to positive along the X axis. The height 2h in FIG. 5(c ) is designed so that when the aberration correction optical element 4d₂ is used to correct the astigmatism shown in FIG. 9(b), the residual RMS wave-front aberration is minimized. FIG. 9(f) shows this residual wave-front aberration, namely, the sum of the solid line and the broken line shown in FIG. 9(b), and it is evident that the absolute value of the residual wave-front aberration is approaching 0λ.

In FIG. 9(c), the arrow aberration generated within the optical system varies from negative, to zero, and then to positive in moving from negative to positive along the X axis, and the RMS wave-front aberration is 0.02 λ. In order to correct this arrow aberration, the aberration correction optical element 4d₃ shown in FIG. 5(d) is used. The arrow aberration generated by the aberration correction optical element 4d₃ varies from positive, to zero, and then to negative in moving from negative to positive along the X axis. The height h in FIG. 5(d) is designed so that when the aberration correction optical element 4d₃ is used to correct the astigmatism shown in FIG. 9(c), the residual RMS wave-front aberration is minimized. FIG. 9(g) shows this residual wave-front aberration, namely, the sum of the solid line and the broken line shown in FIG. 9(c), and it is evident that the absolute value of the residual wave-front aberration is approaching 0 λ.

In FIG. 9(d), the arrow aberration generated within the optical system varies from negative, to zero, and then to positive in moving from negative to positive along the X axis, and the RMS wave-front aberration is 0.04 λ. In order to correct this arrow aberration, the aberration correction optical element 4d₄ shown in FIG. 5(e) is used. The arrow aberration generated by the aberration correction optical element 4d₄ varies from positive, to zero, and then to negative in moving from negative to positive along the X axis. The height 2h in FIG. 5(e) is designed so that when the aberration correction optical element 4d₄ is used to correct the astigmatism shown in FIG. 9(d), the residual RMS wave-front aberration is minimized. FIG. 9(h) shows this residual wave-front aberration, namely, the sum of the solid line and the broken line shown in FIG. 9(d), and it is evident that the absolute value of the residual wave-front aberration is approaching 0 λ.

The wave-front aberration in a cross-section that passes through the center of the aberration correction optical element 4d and is parallel to a direction inclined 60° towards the −Y direction from the +X direction is the same as the wave-front aberration in the cross-section through the center of the optical element in the X direction. Furthermore, the wave-front aberration in a cross-section that passes through the center of the aberration correction optical element 4d and is parallel to a direction inclined 60° towards the +Y direction from the +X direction is the same as the wave-front aberration in the cross-section through the center of the optical element in the X direction.

The arrow aberration generated within the optical system is assumed to have a maximum RMS wave-front aberration of 0.05 λ. Based on this assumption, the four different aberration correction optical elements 4d shown in FIG. 5(b) through FIG. 5(e) are prepared in advance. Then, the amount and sign of the arrow aberration that is generated within the optical system, except the aberration correction optical element 4d, between the semiconductor laser 1 and the objective lens 6, is measured using an interferometer or the like. Based on the measured amount and sign of the arrow aberration, where necessary, the aberration correction optical element 4d which, following correction, is most capable of minimizing the residual RMS wave-front aberration is selected from amongst the four different aberration correction optical elements 4d₁ to 4d₄, and is then inserted into the optical system. Specifically, if the RMS wave-front aberration is no more than 0.01 λ, then arrow aberration correction using an aberration correction optical element 4d is not required. If the RMS wave-front aberration is greater than 0.01 λ but no more than 0.03 λ, then arrow aberration correction is conducted using either the aberration correction optical element 4d₁ shown in FIG. 5(b) or the aberration correction optical element 4d₃ shown in FIG. 5(d), depending on the sign of the arrow aberration. This enables the residual RMS wave-front aberration following correction to be reduced to approximately 0.01 λ or less. If the RMS wave-front aberration is greater than 0.03 λ but no more than 0.05 λ, then arrow aberration correction is conducted using either the aberration correction optical element 4d₂ shown in FIG. 5(c ) or the aberration correction optical element 4d₄ shown in FIG. 5(e), depending on the sign of the arrow aberration. This enables the residual RMS wave-front aberration following correction to be reduced to approximately 0.01 λ or less. In the present embodiment, the number of different aberration correction optical elements 4d was set to 4, but increasing the variety of aberration correction optical elements 4d in terms of the amount and/or sign of the arrow aberration correction enables the residual RMS wave-front aberration following correction to be further reduced.

In FIG. 5 and FIG. 9, the description focused on cases in which the direction of the arrow aberration generated in the optical system was within the X direction, the direction inclined 60° towards the −Y direction from the +X direction, and the direction inclined 60° towards the +Y direction from the +X direction, but even in cases where the arrow aberration generated in the optical system is not within the X direction, the direction inclined 60° towards the −Y direction from the +X direction, and the direction inclined 60° towards the +Y direction from the +X direction, arrow aberration correction can still be achieved by rotating the aberration correction optical element 4d within the plane perpendicular to the optical axis of the incident light, so that the direction of the arrow aberration in the optical system can be substantially matched with the direction of the arrow aberration correction provided by the aberration correction optical element 4d.

In this manner, by preparing a plurality of aberration correction optical elements 4, measuring the aberration within the optical system of the optical head device 21, except the aberration correction optical element 4, and then selecting an aberration correction optical element 4 in accordance with the type, amount, and sign of the measured aberration and incorporating this optical element in the optical head device 21, the present embodiment enables the aberration within the optical system of the optical head device 21 to be reduced with relative ease.

Furthermore, in the present embodiment, the description above focused on those cases in which one aberration correction optical element was used from amongst the different aberration correction optical elements 4a, 4b, 4c, and 4d, thus enabling the correction of one type of optical system aberration from amongst coma, spherical aberration, astigmatism, and arrow aberration, but the correction of two or more types of aberration using two or more aberration correction optical elements is also possible. For example, in those cases in which the aberration generated within the optical path between the semiconductor laser 1 and the objective lens 6 of the optical head device 21 has two different types of aberration from amongst coma, spherical aberration, astigmatism, and arrow aberration, two aberration correction optical elements may be incorporated to enable correction of both types of aberration. Similarly, in those cases in which the aberration generated within the above optical path has three different types of aberration from amongst coma, spherical aberration, astigmatism, and arrow aberration, three aberration correction optical elements may be incorporated to enable correction of each type of aberration. Furthermore, in those cases in which the aberration generated within the above optical path includes all of coma, spherical aberration, astigmatism, and arrow aberration, four aberration correction optical elements may be incorporated to enable correction of each type of aberration.

In addition, in the aberration correction optical elements 4a, 4b, 4c, and 4d shown in FIG. 2 through FIG. 5, the stepped patterns formed of 3 levels, but any number of levels from 2 upwards can be used. As the number of levels is increased, the amount of the residual RMS wave-front aberration can be reduced.

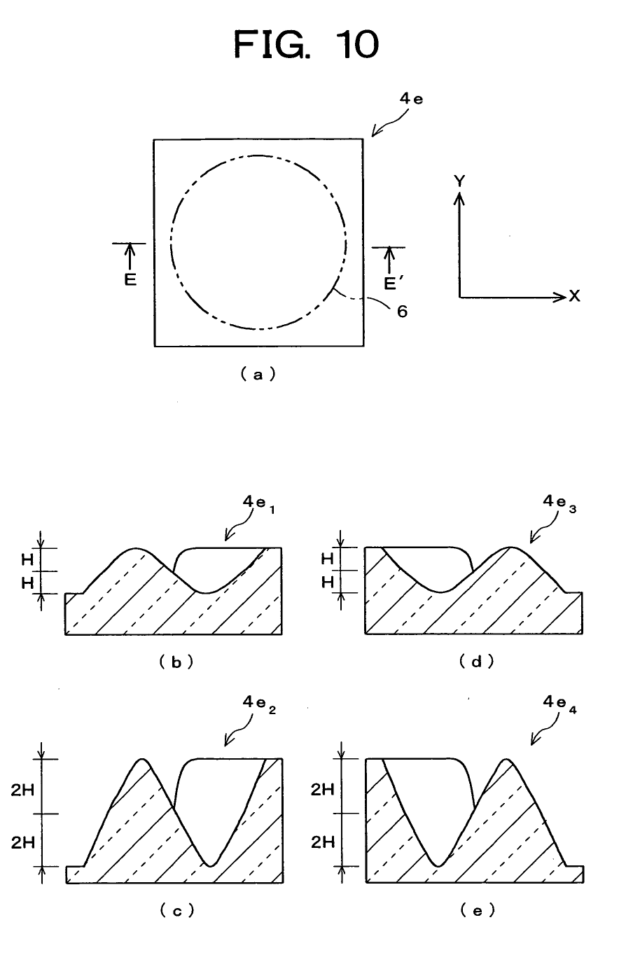

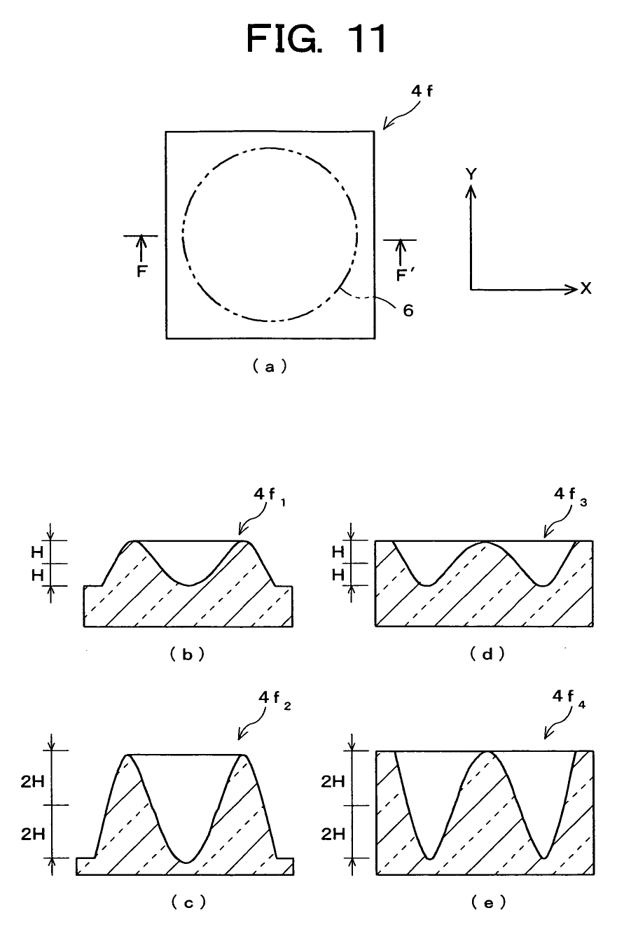

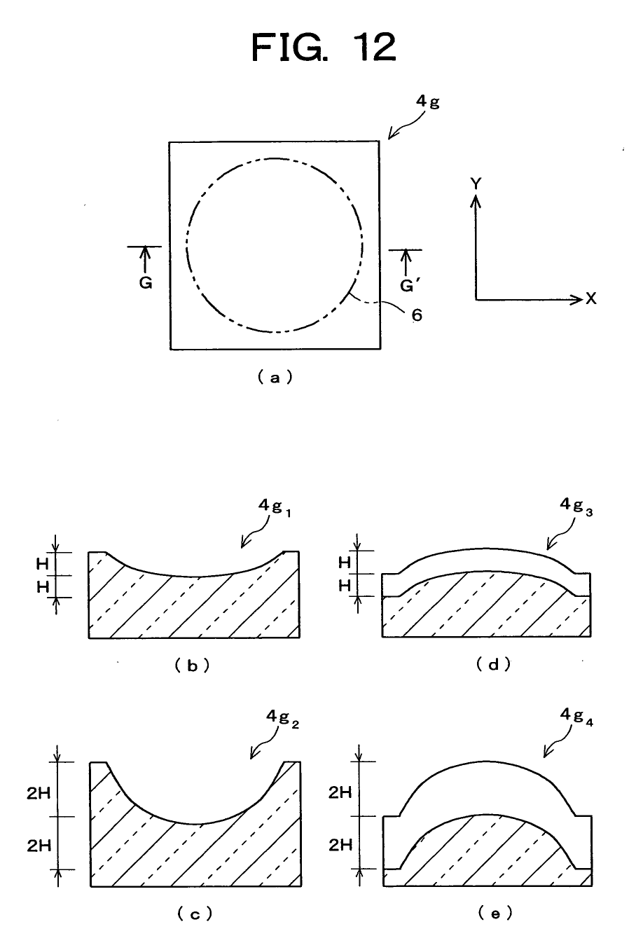

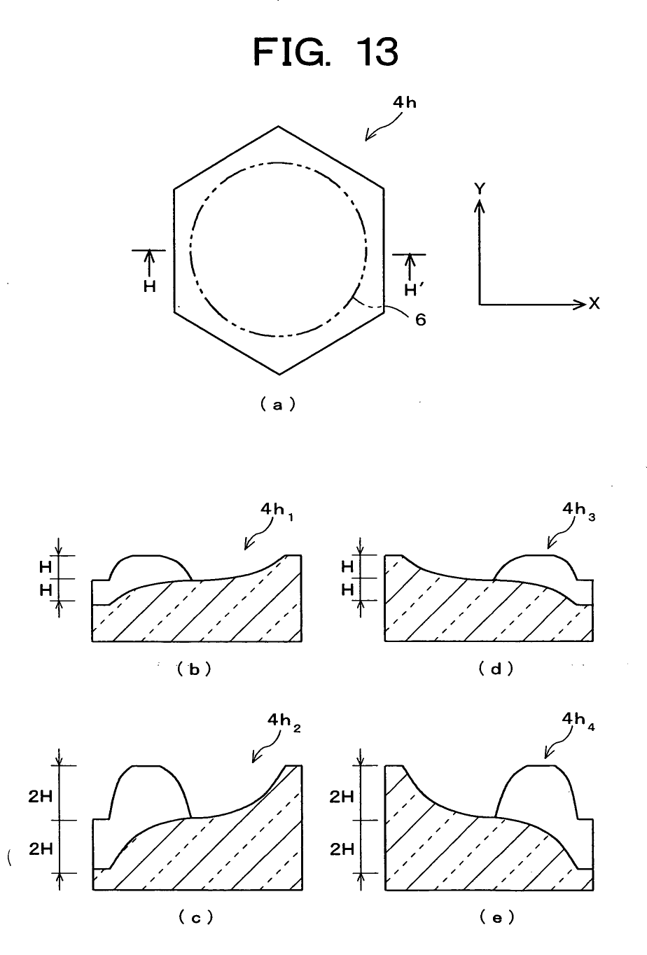

As follows is a description of a second embodiment of the present invention. FIG. 10(a) through FIG. 10(e) are diagrams showing aberration correction optical elements 4e according to the present embodiment, FIG. 11(a) through FIG. 11(e) are diagrams showing aberration correction optical elements 4f according to the present embodiment, FIG. 12(a) through FIG. 12(e) are diagrams showing aberration correction optical elements 4f according to the present embodiment, and FIG. 13(a) through FIG. 13(e) are diagrams showing aberration correction optical elements 4h according to the present embodiment. In each set of drawings, (a) is a plan view, and (b) through (e) are cross-sectional views. The present embodiment differs from the first embodiment in that an aberration correction optical element selected from amongst the aberration correction optical elements 4e to 4h shown in FIG. 10 through FIG. 13 is used as the aberration correction optical element 4. The remaining structures and operations within the present embodiment are the same as those described in the first embodiment.

Next is a description of the aberration correction optical element 4 in the present embodiment. In those cases where coma that occurs in the optical system requires correction, an aberration correction optical element 4e shown in FIG. 10 is used as the aberration correction optical element 4. FIG. 10(a) is a plan view showing the aberration correction optical element 4e. The aberration correction optical element 4e has only a single region, so that the steps provided on the surface of the aberration correction optical element 4a shown in FIG. 2(a) to FIG. 2(e) are replaced with a single overall curved surface. The circle indicated by the broken line in the figure corresponds with the effective area for the objective lens 6. FIG. 10(b) through FIG. 10(e) are cross-sectional views taken along the line E-E′ shown in FIG. 10(a), and represent 4 different aberration correction optical elements 4e with different amounts and/or signs for the coma correction. As shown in FIG. 10(b) through FIG. 10(e), the contour of each element in a cross-section that passes through the center of the element in the X direction is a curve. An aberration correction optical element 4e with this type of cross-sectional shape can be prepared by molding glass or plastic.

In the aberration correction optical element 4e, shown in FIG. 10(b), the height of the element increases and then decreases when traveling from the center of the element along the X axis in the negative direction, whereas the height decreases and then increases when traveling from the center along the X axis in the positive direction. The height at the highest point is higher than the height at the center by a value H, and the height at the lowest point is lower than the height at the center by the same value H. In the aberration correction optical element 4e₂ shown in FIG. 10(c), the height of the element increases and then decreases when traveling from the center of the element along the X axis in the negative direction, whereas the height decreases and then increases when traveling from the center along the X axis in the positive direction. The height at the highest point is higher than the height at the center by a value 2H, and the height at the lowest point is lower than the height at the center by the same value 2H. In the aberration correction optical element 4e₃ shown in FIG. 10(d), the height of the element decreases and then increases when traveling from the center of the element along the X axis in the negative direction, whereas the height increases and then decreases when traveling from the center along the X axis in the positive direction. The height at the highest point is higher than the height at the center by a value H, and the height at the lowest point is lower than the height at the center by the same value H. In the aberration correction optical element 4e₄ shown in FIG. 10(e), the height of the element decreases and then increases when traveling from the center of the element along the X axis in the negative direction, whereas the height increases and then decreases when traveling from the center along the X axis in the positive direction. The height at the highest point is higher than the height at the center by a value 2H, and the height at the lowest point is lower than the height at the center by the same value 2H. In contrast, the cross-section through the center of the aberration correction optical element 4e in the Y direction is flat.

When the aberration correction optical element 4e is used to correct coma that occurs within the optical system, the wave-front aberration within the cross-section that passes-through the center of the aberration correction optical element 4e in the X direction is the same as that shown in FIG. 6. In order to correct the coma shown in FIG. 6(a), the aberration correction optical element 4e₁ shown in FIG. 10(b) is used. The height H in FIG. 10(b) is designed so that the aberration correction optical element 4e₁ can be used to completely correct the coma shown in FIG. 6(a), that is, so that the residual RMS wave-front aberration reduces to 0 λ. In order to correct the coma shown in FIG. 6(b), the aberration correction optical element 4e₂ shown in FIG. 10(c) is used. The height 2H in FIG. 10(c) is designed so that the aberration correction optical element 4e₂ can be used to completely correct the coma shown in FIG. 6(b), that is, so that the residual RMS wave-front aberration reduces to 0 λ. In order to correct the coma shown in FIG. 6(c), the aberration correction optical element 4e₃ shown in FIG. 10(d) is used. The height H in FIG. 10(d) is designed so that the aberration correction optical element 4e₃ can be used to completely correct the coma shown in FIG. 6(c), that is, so that the residual RMS wave-front aberration reduces to 0 λ. In order to correct the coma shown in FIG. 6(d), the aberration correction optical element 4e₄ shown in FIG. 10(e) is used. The height 2H in FIG. 10(e) is designed so that the aberration correction optical element 4e₄ can be used to completely correct the coma shown in FIG. 6(d), that is, so that the residual RMS wave-front aberration reduces to 0 λ.

In contrast, the wave-front aberration in the cross-section through the center of the aberration correction optical element 4e in the Y direction is 0 λ.

The coma generated within the optical system is assumed to have a maximum RMS wave-front aberration of 0.05 λ. Based on this assumption, the four different aberration correction optical elements 4e shown in FIG. 10(b) through FIG. 10(e) are prepared in advance. Then, the amount and sign of the coma that is generated within the optical system, except the aberration correction optical element 4e, between the semiconductor laser 1 and the objective lens 6, is measured using an interferometer or the like. Based on the measured amount and sign of the coma, where necessary, the aberration correction optical element 4e which, following correction, is most capable of minimizing the residual RMS wave-front aberration is selected from amongst the four different aberration correction optical elements 4e, and is then inserted into the optical system. Specifically, if the RMS wave-front aberration is no more than 0.01 λ, then coma correction using an aberration correction optical element 4e is not required. If the RMS wave-front aberration is greater than 0.01 λ but no more than 0.03 λ, then coma correction is conducted using either the aberration correction optical element 4e₁ shown in FIG. 10(b) or the aberration correction optical element 4e₃ shown in FIG. 10(d), depending on the sign of the coma. This enables the residual RMS wave-front aberration following correction to be reduced to no more than 0.01 λ. If the RMS wave-front aberration is greater than 0.03 λ but no more than 0.05 λ, then coma correction is conducted using either the aberration correction optical element 4e₂ shown in FIG. 10(c) or the aberration correction optical element 4e₄ shown in FIG. 10(e), depending on the sign of the coma. This enables the residual RMS wave-front aberration following correction to be reduced to no more than 0.01 λ. In the present embodiment, the number of different aberration correction optical elements 4e was set to 4, but increasing the variety of aberration correction optical elements 4e in terms of the amount and/or sign of the coma correction enables the residual RMS wave-front aberration following correction to be further reduced.

In FIG. 10, the description focused on cases in which the direction of the coma generated in the optical system was within the X direction, but even in cases where the coma generated in the optical system is not within the X direction, coma correction can still be achieved by rotating the aberration correction optical element 4e within the plane perpendicular to the optical axis of the incident light, so that the direction of the coma in the optical system can be substantially matched with the direction of the coma correction provided by the aberration correction optical element 4e.

In those cases where spherical aberration that occurs in the optical system requires correction, an aberration correction optical element 4f shown in FIG. 11 is used as the aberration correction optical element 4. FIG. 11(a) is a plan view showing the aberration correction optical element 4f. The aberration correction optical element 4f has only a single region, so that the steps provided on the surface of the aberration correction optical element 4b shown in FIG. 3(a) to FIG. 3(e) are replaced with a single overall curved surface. The circle indicated by the broken line in the figure corresponds with the effective area for the objective lens 6. FIG. 11(b) through FIG. 11(e) are cross-sectional views taken along the line F-F′ shown in FIG. 11(a), and represent 4 different aberration correction optical elements 4f with different amounts and/or signs for the spherical aberration correction. As shown in FIG. 11(b) through FIG. 11(e), the contour of each element in a cross-section that passes through the center of the element in the X direction is a curve. An aberration correction optical element 4f with this type of cross-sectional shape can be prepared by molding glass or plastic.

In the aberration correction optical element 4f₁ shown in FIG. 11(b), the height of the element increases and then decreases when traveling from the center of the element along the X axis in both the positive and negative directions. The height at the highest point is higher than the height at the lowest point by a value 2H. In the aberration correction optical element 4f₂ shown in FIG. 11(c), the height of the element increases and then decreases when traveling from the center of the element along the X axis in both the positive and negative directions. The height at the highest point is higher than the height at the lowest point by a value 4H. In the aberration correction optical element 4f₃ shown in FIG. 11(d), the height of the element decreases and then increases when traveling from the center of the element along the X axis in both the positive and negative directions. The height at the highest point is higher than the height at the lowest point by a value 2H. In the aberration correction optical element 4f₄ shown in FIG. 11(e), the height of the element decreases and then increases when traveling from the center of the element along the X axis in both the positive and negative directions. The height at the highest point is higher than the height at the lowest point by a value 4H. The cross-section through the center of the aberration correction optical element 4f in the Y direction is the same as the cross-section through the center of the optical element in the X direction.

When the aberration correction optical element 4f is used to correct spherical aberration that occurs within the optical system, the wave-front aberration within the cross-section that passes through the center of the aberration correction optical element 4f in the X direction is the same as that shown in FIG. 7. In other words, in order to correct the spherical aberration shown in FIG. 7(a), the aberration correction optical element 4f₁ shown in FIG. 11(b) is used. The height H in FIG. 11(b) is designed so that the aberration correction optical element 4f, can be used to completely correct the spherical aberration shown in FIG. 7(a), that is, so that the residual RMS wave-front aberration reduces to 0 λ. In order to correct the spherical aberration shown in FIG. 7(b), the aberration correction optical element 4f₂ shown in FIG. 11(c) is used. The height 2H in FIG. 11(c) is designed so that the aberration correction optical element 4f₂ can be used to completely correct the spherical aberration shown in FIG. 7(b), that is, so that the residual RMS wave-front aberration reduces to 0 λ. In order to correct the spherical aberration shown in FIG. 7(c), the aberration correction optical element 4f₃ shown in FIG. 11(d) is used. The height H in FIG. 11(d) is designed so that the aberration correction optical element 4f₃ can be used to completely correct the spherical aberration shown in FIG. 7(c), that is, so that the residual RMS wave-front aberration reduces to 0 λ. In order to correct the spherical aberration shown in FIG. 7(d), the aberration correction optical element 4f₄ shown in FIG. 11(e) is used. The height 2H in FIG. 11(e) is designed so that the aberration correction optical element 4f₄ can be used to completely correct the spherical aberration shown in FIG. 7(d), that is, so that the residual RMS wave-front aberration reduces to 0 λ.

The wave-front aberration in the cross-section through the center of the aberration correction optical element 4f in the Y direction is the same as the wave-front aberration in the cross-section through the center of the optical element in the X direction.

The spherical aberration generated within the optical system is assumed to have a maximum RMS wave-front aberration of 0.05 λ. Based on this assumption, the four different aberration correction optical elements 4f shown in FIG. 11(b) through FIG. 11(e) are prepared in advance. Then, the amount and sign of the spherical aberration that is generated within the optical system, except the aberration correction optical element 4f, between the semiconductor laser 1 and the objective lens 6, is measured using an interferometer or the like. Based on the measured amount and sign of the spherical aberration, where necessary, the aberration correction optical element 4f which, following correction, is most capable of minimizing the residual RMS wave-front aberration is selected from amongst the four different aberration correction optical elements 4f, and is then inserted into the optical system. Specifically, if the RMS wave-front aberration is no more than 0.01 λ, then spherical aberration correction using an aberration correction optical element 4f is not required. If the RMS wave-front aberration is greater than 0.01λ but no more than 0.03 λ, then spherical aberration correction is conducted using either the aberration correction optical element 4f, shown in FIG. 11(b) or the aberration correction optical element 4f₃ shown in FIG. 11(d), depending on the sign of the spherical aberration. This enables the residual RMS wave-front aberration following correction to be reduced to no more than 0.01 λ. If the RMS wave-front aberration is greater than 0.03 λ but no more than 0.05 λ, then spherical aberration correction is conducted using either the aberration correction optical element 4f₂ shown in FIG. 11(c) or the aberration correction optical element 4f₄ shown in FIG. 11(e), depending on the sign of the spherical aberration. This enables the residual RMS wave-front aberration following correction to be reduced to no more than 0.01 λ. In the present embodiment, the number of different aberration correction optical elements 4f was set to 4, but increasing the variety of aberration correction optical elements 4f in terms of the amount and/or sign of the spherical aberration correction enables the residual RMS wave-front aberration following correction to be further reduced.

In those cases where astigmatism that occurs in the optical system requires correction, an aberration correction optical element 4g shown in FIG. 12 is used as the aberration correction optical element 4. FIG. 12(a) is a plan view showing the aberration correction optical element 4g. The aberration correction optical element 4g has only a single region, so that the steps provided on the surface of the aberration correction optical element 4c shown in FIG. 4(a) to FIG. 4(e) are replaced with a single overall curved surface. The circle indicated by the broken line in the figure corresponds with the effective area for the objective lens 6. FIG. 12(b) through FIG. 12(e) are cross-sectional views taken along the line G-G′ shown in FIG. 12(a), and represent 4 different aberration correction optical elements 4g with different amounts and/or signs for the astigmatism correction. As shown in FIG. 12(b) through FIG. 12(e), the contour of each element in a cross-section that passes through the center of the element in the X direction is a curve. An aberration correction optical element 4g with this type of cross-sectional shape can be prepared by molding glass or plastic.

In the aberration correction optical element 4g₁ shown in FIG. 12(b), the height of the element increases from the center of the element in both the positive and negative directions along the X axis. The height at the highest point is higher than the height at the center by a value H. In the aberration correction optical element 4g₂ shown in FIG. 12(c), the height of the element increases from the center of the element in both the positive and negative directions along the X axis. The height at the highest point is higher than the height at the center by a value 2H. In the aberration correction optical element 4g₃ shown in FIG. 12(d), the height of the element decreases from the center of the element in both the positive and negative directions along the X axis. The height at the lowest point is lower than the height at the center by a value H. In the aberration correction optical element 4g₄ shown in FIG. 12(e), the height of the element decreases from the center of the element in both the positive and negative directions along the X axis. The height at the lowest point is lower than the height at the center by a value 2H.

The contour of the element in a cross-section through the center of the aberration correction optical element 4g in the Y direction is a curve that is similar to the cross-section through the center of the optical element in the X direction. However, in the aberration correction optical element 4g₁ shown in FIG. 12(b), the height of the element decreases from the center of the element in both the positive and negative directions along the Y axis. The height at the lowest point is lower than the height at the center by a value H. In the aberration correction optical element 4g₂ shown in FIG. 12(c), the height of the element decreases from the center of the element in both the positive and negative directions along the Y axis. The height at the lowest point is lower than the height at the center by a value 2H. In the aberration correction optical element 4g₃ shown in FIG. 12(d), the height of the element increases from the center of the element in both the positive and negative directions along the Y axis. The height at the highest point is higher than the height at the center by a value H. In the aberration correction optical element 4g₄ shown in FIG. 12(e), the height of the element increases from the center of the element in both the positive and negative directions along the Y axis. The height at the highest point is higher than the height at the center by a value 2H.

When the aberration correction optical element 4g is used to correct astigmatism that occurs within the optical system, the wave-front aberration within the cross-section that passes through the center of the aberration correction optical element 4g in the X direction is the same as that shown in FIG. 8. In other words, in order to correct the astigmatism shown in FIG. 8(a), the aberration correction optical element 4g₁ shown in FIG. 12(b) is used. The height H in FIG. 12(b) is designed so that the aberration correction optical element 4g₁ can be used to completely correct the astigmatism shown in FIG. 8(a), that is, so that the residual RMS wave-front aberration reduces to 0 λ. In order to correct the astigmatism shown in FIG. 8(b), the aberration correction optical element 4g₂ shown in FIG. 12(c) is used. The height 2H in FIG. 12(c) is designed so that the aberration correction optical element 4g₂ can be used to completely correct the astigmatism shown in FIG. 8(b), that is, so that the residual RMS wave-front aberration reduces to 0 λ. In order to correct the astigmatism shown in FIG. 8(c), the aberration correction optical element 4g₃ shown in FIG. 12(d) is used. The height H in FIG. 12(d) is designed so that the aberration correction optical element 4g₃ can be used to completely correct the astigmatism shown in FIG. 8(c), that is, so that the residual RMS wave-front aberration reduces to 0 λ. In order to correct the astigmatism shown in FIG. 8(d), the aberration correction optical element 4g₄ shown in FIG. 12(e) is used. The height 2H in FIG. 12(e) is designed so that the aberration correction optical element 4g₄ can be used to completely correct the astigmatism shown in FIG. 8(d), that is, so that the residual RMS wave-front aberration reduces to 0 λ.

The wave-front aberration in the cross-section through the center of the aberration correction optical element 4g in the Y direction has the opposite sign to the wave-front aberration in the cross-section through the center of the optical element in the X direction.

The astigmatism generated within the optical system is assumed to have a maximum RMS wave-front aberration of 0.05 λ. Based on this assumption, the four different aberration correction optical elements 4g shown in FIG. 12(b) through FIG. 12(e) are prepared in advance. Then, the amount and sign of the astigmatism that is generated within the optical system, except the aberration correction optical element 4g, between the semiconductor laser 1 and the objective lens 6, is measured using an interferometer or the like. Based on the measured amount and sign of the astigmatism, where necessary, the aberration correction optical element 4g which, following correction, is most capable of minimizing the residual RMS wave-front aberration is selected from amongst the four different aberration correction optical elements 4g, and is then inserted into the optical system. Specifically, if the RMS wave-front aberration is no more than 0.01 λ, then astigmatism correction using an aberration correction optical element 4g is not required. If the RMS wave-front aberration is greater than 0.01 λ but no more than 0.03 λ, then astigmatism correction is conducted using either the aberration correction optical element 4g₁ shown in FIG. 12(b) or the aberration correction optical element 4g₃ shown in FIG. 12(d), depending on the sign of the astigmatism. This enables the residual RMS wave-front aberration following correction to be reduced to no more than 0.01 λ. If the RMS wave-front aberration is greater than 0.03 λ but no more than 0.05 λ, then astigmatism correction is conducted using either the aberration correction optical element 4g₂ shown in FIG. 12(c) or the aberration correction optical element 4g₄ shown in FIG. 12(e), depending on the sign of the astigmatism. This enables the residual RMS wave-front aberration following correction to be reduced to no more than 0.01 λ. In the present embodiment, the number of different aberration correction optical elements 4g was set to 4, but increasing the variety of aberration correction optical elements 4g in terms of the amount and/or sign of the astigmatism correction enables the residual RMS wave-front aberration following correction to be further reduced.

In FIG. 12, the description focused on cases in which the direction of the astigmatism generated in the optical system was within the X-Y direction, but even in cases where the astigmatism generated in the optical system is not within the X-Y direction, astigmatism correction can still be achieved by rotating the aberration correction optical element 4g within the plane perpendicular to the optical axis of the incident light, so that the direction of the astigmatism in the optical system can be substantially matched with the direction of the astigmatism correction provided by the aberration correction optical element 4g.

In those cases where arrow aberration that occurs in the optical system requires correction, an aberration correction optical element 4h shown in FIG. 13 is used as the aberration correction optical element 4. FIG. 13(a) is a plan view showing the aberration correction optical element 4h. The aberration correction optical element 4h has only a single region, so that the steps provided on the surface of the aberration correction optical element 4d shown in FIG. 5(a) to FIG. 5(e) are replaced with a single overall curved surface. The circle indicated by the broken line in the figure corresponds with the effective area for the objective lens 6. FIG. 13(b) through FIG. 13(e) are cross-sectional views taken along the line H-H′ shown in FIG. 13(a), and represent 4 different aberration correction optical elements 4h with different amounts and/or signs for the arrow aberration correction. As shown in FIG. 13(b) through FIG. 13(e), the contour of each element in a cross-section that passes through the center of the element in the X direction is a curve. An aberration correction optical element 4h with this type of cross-sectional shape can be prepared by molding glass or plastic.

In the aberration correction optical element 4h₁ shown in FIG. 13(b), the height of the element decreases when traveling from the center of the element along the X axis in the negative direction, whereas the height increases when traveling from the center along the X axis in the positive direction. The height at the highest point is higher than the height at the center by a value H, and the height at the lowest point is lower than the height at the center by the same value H. In the aberration correction optical element 4h₂ shown in FIG. 13(c), the height of the element decreases when traveling from the center of the element along the X axis in the negative direction, whereas the height increases when traveling from the center along the X axis in the positive direction. The height at the highest point is higher than the height at the center by a value 2H, and the height at the lowest point is lower than the height at the center by the same value 2H. In the aberration correction optical element 4h₃ shown in FIG. 13(d), the height of the element increases when traveling from the center of the element along the X axis in the negative direction, whereas the height decreases when traveling from the center along the X axis in the positive direction. The height at the highest point is higher than the height at the center by a value H, and the height at the lowest point is lower than the height at the center by the same value H. In the aberration correction optical element 4h₄ shown in FIG. 13(e), the height of the element increases when traveling from the center of the element along the X axis in the negative direction, whereas the height decreases when traveling from the center along the X axis in the positive direction. The height at the highest point is higher than the height at the center by a value 2H, and the height at the lowest point is lower than the height at the center by the same value 2H.

The contour of the cross-section that passes through the center of the aberration correction optical element 4h and is parallel to a direction inclined 60° towards the −Y direction from the +X direction is a similar curve to the cross-section in the X direction. In the aberration correction optical element 4h₁ shown in FIG. 13(b), the height of the element decreases when traveling from the center of the element along the direction inclined 60° towards the −Y direction from the +X direction, whereas the height increases when traveling from the center of the element along the direction inclined 60° towards the +Y direction from the −X direction. The height at the highest point is higher than the height at the center by a value H, and the height at the lowest point is lower than the height at the center by the same value H. In the aberration correction optical element 4h₂ shown in FIG. 13(c), the height of the element decreases when traveling from the center of the element along the direction inclined 60° towards the −Y direction from the +X direction, whereas the height increases when traveling from the center of the element along the direction inclined 60° towards the +Y direction from the −X direction. The height at the highest point is higher than the height at the center by a value 2H, and the height at the lowest point is lower than the height at the center by the same value 2H. In the aberration correction optical element 4h₃ shown in FIG. 13(d), the height of the element increases when traveling from the center of the element along the direction inclined 60° towards the −Y direction from the +X direction, whereas the height decreases when traveling from the center of the element along the direction inclined 60° towards the +Y direction from the −X direction. The height at the highest point is higher than the height at the center by a value H, and the height at the lowest point is lower than the height at the center by the same value H. In the aberration correction optical element 4h₄ shown in FIG. 13(e), the height of the element increases when traveling from the center of the element along the direction inclined 60° towards the −Y direction from the +X direction, whereas the height decreases when traveling from the center of the element along the direction inclined 60° towards the +Y direction from the −X direction. The height at the highest point is higher than the height at the center by a value 2H, and the height at the lowest point is lower than the height at the center by the same value 2H.

Furthermore, the contour of the cross-section that passes through the center of the aberration correction optical element 4h and is parallel to a direction inclined 60° towards the +Y direction from the +X direction is also a similar curve to the cross-section in the X direction. In the aberration correction optical element 4h₁ shown in FIG. 13(b), the height of the element decreases when traveling from the center of the element along the direction inclined 60° towards the +Y direction from the +X direction, whereas the height increases when traveling from the center of the element along the direction inclined 60° towards the −Y direction from the −X direction. The height at the highest point is higher than the height at the center by a value H, and the height at the lowest point is lower than the height at the center by the same value H. In the aberration correction optical element 4h₂ shown in FIG. 13(c), the height of the element decreases when traveling from the center of the element along the direction inclined 60° towards the +Y direction from the +X direction, whereas the height increases when traveling from the center of the element along the direction inclined 60° towards the −Y direction from the −X direction. The height at the highest point is higher than the height at the center by a value 2H, and the height at the lowest point is lower than the height at the center by the same value 2H. In the aberration correction optical element 4h₃ shown in FIG. 13(d), the height of the element increases when traveling from the center of the element along the direction inclined 60° towards the +Y direction from the +X direction, whereas the height decreases when traveling from the center of the element along the direction inclined 60° towards the −Y direction from the −X direction. The height at the highest point is higher than the height at the center by a value H, and the height at the lowest point is lower than the height at the center by the same value H. In the aberration correction optical element 4h₄ shown in FIG. 13(e), the height of the element increases when traveling from the center of the element along the direction inclined 60° towards the +Y direction from the +X direction, whereas the height decreases when traveling from the center of the element along the direction inclined 60° towards the −Y direction from the −X direction. The height at the highest point is higher than the height at the center by a value 2H, and the height at the lowest point is lower than the height at the center by the same value 2H.

When the aberration correction optical element 4h is used to correct arrow aberration that occurs within the optical system, the wave-front aberration within the cross-section that passes through the center of the aberration correction optical element 4h in the X direction is the same as that shown in FIG. 9. In other words, in order to correct the arrow aberration shown in FIG. 9(a), the aberration correction optical element 4h₁ shown in FIG. 13(b) is used. The height H in FIG. 13(b) is designed so that the aberration correction optical element 4h₁ can be used to completely correct the arrow aberration shown in FIG. 9(a), that is, so that the residual RMS wave-front aberration reduces to 0 λ. In order to correct the arrow aberration shown in FIG. 9(b), the aberration correction optical element 4h₂ shown in FIG. 13(c) is used. The height 2H in FIG. 13(c) is designed so that the aberration correction optical element 4h₂ can be used to completely correct the arrow aberration shown in FIG. 9(b), that is, so that the residual RMS wave-front aberration reduces to 0 λ. In order to correct the arrow aberration shown in FIG. 9(c), the aberration correction optical element 4h₃ shown in FIG. 13(d) is used. The height H in FIG. 13(d) is designed so that the aberration correction optical element 4h₃ can be used to completely correct the arrow aberration shown in FIG. 9(c), that is, so that the residual RMS wave-front aberration reduces to 0 λ. In order to correct the arrow aberration shown in FIG. 9(d), the aberration correction optical element 4h₄ shown in FIG. 13(e) is used. The height 2H in FIG. 13(e) is designed so that the aberration correction optical element 4h₄ can be used to completely correct the arrow aberration shown in FIG. 9(d), that is, so that the residual RMS wave-front aberration reduces to 0 λ.

The wave-front aberration in a cross-section that passes through the center of the aberration correction optical element 4h and is parallel to a direction inclined 60° towards the −Y direction from the +X direction is the same as the wave-front aberration in the cross-section through the center of the optical element in the X direction. Furthermore, the wave-front aberration in a cross-section that passes through the center of the aberration correction optical element 4h and is parallel to a direction inclined 60° towards the +Y direction from the +X direction is also the same as the wave-front aberration in the cross-section through the center of the optical element in the X direction.

The arrow aberration generated within the optical system is assumed to have a maximum RMS wave-front aberration of 0.05 λ. Based on this assumption, the four different aberration correction optical elements 4h shown in FIG. 13(b) through FIG. 13(e) are prepared in advance. Then, the amount and sign of the arrow aberration that is generated within the optical system, except the aberration correction optical element 4h, between the semiconductor laser 1 and the objective lens 6, is measured using an interferometer or the like. Based on the measured amount and sign of the arrow aberration, where-necessary, the aberration correction optical element 4h which, following correction, is most capable of minimizing the residual RMS wave-front aberration is selected from amongst the four different aberration correction optical elements 4h, and is then inserted into the optical system. Specifically, if the RMS wave-front aberration is no more than 0.01 λ, then arrow aberration correction using an aberration correction optical element 4h is not required. If the RMS wave-front aberration is greater than 0.01 λ but no more than 0.03 λ, then arrow aberration correction is conducted using either the aberration correction optical element 4h₁ shown in FIG. 13(b) or the aberration correction optical element 4h₃ shown in FIG. 13(d), depending on the sign of the arrow aberration. This enables the residual RMS wave-front aberration following correction to be reduced to no more than 0.01 λ. If the RMS wave-front aberration is greater than 0.03 λ but no more than 0.05 λ, then arrow aberration correction is conducted using either the aberration correction optical element 4h₂ shown in FIG. 13(c) or the aberration correction optical element 4h₄ shown in FIG. 13(e), depending on the sign of the arrow aberration. This enables the residual RMS wave-front aberration following correction to be reduced to no more than 0.01 λ. In the present embodiment, the number of different aberration correction optical elements 4h was set to 4, but increasing the variety of aberration correction optical elements 4h in terms of the amount and/or sign of the arrow aberration correction enables the residual RMS wave-front aberration following correction to be further reduced.

In FIG. 13, the description focused on cases in which the direction of the arrow aberration generated in the optical system was within the X direction, the direction inclined 60° towards the −Y direction from the +X direction, and the direction inclined 60° towards the +Y direction from the +X direction, but even in cases where the arrow aberration generated in the optical system is not within the X direction, the direction inclined 60° towards the −Y direction from the +X direction, and the direction inclined 60° towards the +Y direction from the +X direction, arrow aberration correction can still be achieved by rotating the aberration correction optical element 4h within the plane perpendicular to the optical axis of the incident light, so that the direction of the arrow aberration in the optical system can be substantially matched with the direction of the arrow aberration correction provided by the aberration correction optical element 4h.

In the present embodiment, the description above focused on those cases in which one aberration correction optical element was used from amongst the different aberration correction optical elements 4e, 4f, 4g, and 4h, thus enabling the correction of one type of optical system aberration from amongst coma, spherical aberration, astigmatism, and arrow aberration, but the correction of two or more types of aberration using two or more aberration correction optical elements is also possible.

In the present embodiment, unlike the first embodiment described above, the aberration correction optical elements are designed with curved surfaces to enable the aberration within the optical system to be completely corrected, meaning the optical system aberration can be corrected with greater accuracy. However, the design and manufacture of the aberration correction optical elements is somewhat more difficult than in the first embodiment. The other effects provided by the present embodiment are the same as those observed for the first embodiment.

In the first and second embodiments described above, optical information recording and playback apparatus capable of both recording to, and playback from, the disc 7 were described. However, the present invention is not limited to this configuration, and can also be applied to read-only apparatus which perform only playback from the disc 7. In this case, the semiconductor laser 1 is not driven by the semiconductor laser drive circuit 13 on the basis of a recording signal, but is rather driven with a constant output.

Furthermore, the optical information recording and playback apparatus according to the first and second embodiments are not limited to DVD drives, and can also be used in read-only apparatus, DVD-R (Digital Versatile Disc Recordable) drives, DVD-ROM (Digital Versatile Disc—Read Only Memory) drives, and DVD-RW (Digital Versatile Disc ReWritable) drives, as well as in CD-R (Compact Disc Recordable) and CD-ROM (Compact Disc Read Only Memory).

### INDUSTRIAL APPLICABILITY

The present invention relates to an optical head device for recording to, and/or conducting playback from, an optical recording medium such as DVD, DVD-R, DVD-ROM, DVD-RW, CD-R, and CD-ROM, as well as a method of manufacturing such an optical head device, and an optical information recording and/or playback apparatus.

1. An optical head device comprising: a light source; an objective lens for focusing light emitted from this light source onto an optical recording medium; a photodetector for detecting light reflected off said optical recording medium; and one or more aberration correction optical elements which are disposed within a path of said light between said light source and said objective lens, and correct aberration of said light generated within that path, wherein said one or more aberration correction optical elements are selected from amongst a plurality of different aberration correction optical elements, in accordance with said aberration.

2. The optical head device according to claim 1, wherein said plurality of different aberration correction optical elements provide correction for mutually different types, signs, and quantities of aberration.

3. The optical head device according to claim 1, wherein said aberration is one type of aberration selected from coma, spherical aberration, astigmatism, and arrow aberration, a single aberration correction optical element is placed within the path of said light, and the single aberration correction optical element corrects said one type of aberration.

4. The optical head device according to claim 1, wherein said aberration includes two types of aberration selected from coma, spherical aberration, astigmatism, and arrow aberration, two aberration correction optical elements are placed within the path of said light, and one of the two aberration correction optical elements corrects one of said two types of aberration, while another of said two aberration correction optical elements corrects another of said two types of aberration.

5. The optical head device according to claim 1, wherein said aberration includes three types of aberration selected from coma, spherical aberration, astigmatism, and arrow aberration, three aberration correction optical elements are placed within the path of said light, and of said three aberration correction optical elements, one aberration correction optical element corrects one of said three types of aberration, another of said three aberration correction optical elements corrects another of said three types of aberration, and yet another of said three aberration correction optical elements corrects yet another of said three types of aberration.

6. The optical head device according to claim 1, wherein said aberration includes coma, spherical aberration, astigmatism, and arrow aberration, four aberration correction optical elements are placed within the path of said light, and a first aberration correction optical element of the four aberration correction optical elements corrects said coma, a second aberration correction optical element corrects said spherical aberration, a third aberration correction optical element corrects said astigmatism, and a fourth aberration correction optical element corrects said arrow aberration.

7. The optical head device according to claim 1, wherein at least one of a light incident surface and a light exit surface of said aberration correction optical element is a stepped surface comprising at least 2 steps.

8. The optical head device according to claim 1, wherein at least one of a light incident surface and a light exit surface of said aberration correction optical element is formed as a curved surface.

9. The optical head device according to claim 1, wherein said aberration includes coma, and an aberration correction optical element placed within the path of said light is installed so that a direction of aberration corrected by the aberration correction optical element substantially matches a direction of said coma.

10. The optical head device according to claim 1, wherein said aberration includes astigmatism, and an aberration correction optical element placed within the path of said light is installed so that a direction of aberration corrected by the aberration correction optical element substantially matches a direction of said astigmatism.

11. The optical head device according to claim 1, wherein said aberration includes arrow aberration, and an aberration correction optical element placed within the path of said light is installed so that a direction of aberration corrected by the aberration correction optical element substantially matches a direction of said arrow aberration.

12. A method of manufacturing an optical head device comprising the steps of: assembling an optical system including a light source, an objective lens for focusing light emitted from this light source onto an optical recording medium, and a photodetector for detecting light reflected off the optical recording medium; measuring aberration generated in a light path within the optical system from said light source to said objective lens; and selecting, from amongst a plurality of different aberration correction optical elements, based on the results of the measured aberration, one or more aberration correction optical elements for correcting the aberration of said light, and then installing the optical element or elements within said light path of said optical system.

13. The method of manufacturing an optical head device according to claim 12, wherein said plurality of different aberration correction optical elements provide correction for mutually different types, signs, and quantities of aberration.

14. The method of manufacturing an optical head device according to claim 12, wherein the step of installing said one or more aberration correction optical elements within the optical system comprises the step of rotating said aberration correction optical element, using an optical axis of said light as a rotational axis, so that a direction of aberration corrected by said aberration correction optical element matches a direction of aberration generated within the path of said light.

15. An optical information recording and/or playback apparatus comprising: the optical head device according to claim 1; a first circuit for driving said light source; a second circuit for generating a playback signal and an error signal based on an output signal from said photodetector; and a third circuit for controlling a position of said objective lens based on said error signal.

16. The optical information recording and/or playback apparatus according to claim 15, wherein said first circuit is for driving said light source in accordance with a recording signal.

17. The optical information recording and/or playback apparatus according to claim 15, wherein said first circuit is for driving said light source with a constant output.
